(19) United States
(12) Patent Application Publication
(10) Pub. No.: US 2025/0119222 A1
(43) Pub. Date: Apr. 10, 2025

(54) EXPLICIT AND IMPLICIT PRECODER INDICATION FOR DEMODULATION REFERENCE SIGNAL-BASED CHANNEL STATE INFORMATION REPORTING

(71) Applicant: QUALCOMM Incorporated, San Diego, CA (US)

(72) Inventors: Qiaoyu LI, Beijing (CN); Juan MONTOJO, San Diego, CA (US); Mahmoud TAHERZADEH BOROUJENI, San Diego, CA (US); Tao LUO, San Diego, CA (US)

(21) Appl. No.: 18/729,784

(22) PCT Filed: Mar. 23, 2022
(86) PCT No.: PCT/CN2022/082431

§ 371 Date: Jul. 17, 2024

(51) Int. Cl. H04B 17/318; H04B 7/06; H04L 5/00; H04W 72/11

(52) U.S. Cl. CPC H04B 17/328; H04B 7/06968; H04L 5/0051; H04W 72/11

(57) ABSTRACT

Methods, systems, and devices for wireless communications are described. A user equipment (UE) may transmit a first report indicating a measurement for a first beam based at least in part on a source reference signal to a network entity. The network entity may transmit control signaling configuring the UE to report a differential measurement for the source reference signal. The UE may determine the differential measurement for the source reference signal by measuring a demodulation reference signal that is quasi co-located with the reference signal. The UE may transmit a second report indicating the differential measurement for the source reference signal to the network entity.

### CROSS REFERENCE

The present Application is a 371 national phase filing of International PCT Application No. PCT/CN2022/082431 by LI et al., entitled “EXPLICIT AND IMPLICIT PRECODER INDICATION FOR DEMODULATION REFERENCE SIGNAL-BASED CHANNEL STATE INFORMATION REPORTING,” filed Mar. 23, 2022, which is assigned to the assignee hereof, and which is expressly incorporated by reference in its entirety herein.

### FIELD OF TECHNOLOGY

The following relates to wireless communications, including explicit and implicit precoder indication for demodulation reference signal-based channel state information reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support explicit and implicit precoder indication for demodulation reference signal (DMRS)-based channel state information (CSI) reporting. For example, the described techniques provide for deriving differential beam qualities based on source reference signals.

A method for wireless communications at a user equipment (UE) is described. The method may include transmitting, to a first network entity, a first report indicating a measurement for a first beam based on a source reference signal, receiving control signaling configuring the UE to report a differential measurement for the source reference signal, where the control signaling includes an indication of the source reference signal from a set of multiple source reference signals that are quasi co-located with a set of multiple DMRSs, determining the differential measurement for the source reference signal based on measuring a DMRS that is quasi co-located with the source reference signal, where the differential measurement is determined with reference to a most recently reported beam measurement for the source reference signal, and transmitting, to the first network entity, a second report indicating the differential measurement for the source reference signal.

An apparatus for wireless communications at a UE is described. The apparatus may include a processor, memory coupled with the processor, and instructions stored in the memory. The instructions may be executable by the processor to cause the apparatus to transmit, to a first network entity, a first report indicating a measurement for a first beam based on a source reference signal, receive control signaling configuring the UE to report a differential measurement for the source reference signal, where the control signaling includes an indication of the source reference signal from a set of multiple source reference signals that are quasi co-located with a set of multiple DMRSs, determine the differential measurement for the source reference signal based on measuring a DMRS that is quasi co-located with the source reference signal, where the differential measurement is determined with reference to a most recently reported beam measurement for the source reference signal, and transmit, to the first network entity, a second report indicating the differential measurement for the source reference signal.

Another apparatus for wireless communications at a UE is described. The apparatus may include means for transmitting, to a first network entity, a first report indicating a measurement for a first beam based on a source reference signal, means for receiving control signaling configuring the UE to report a differential measurement for the source reference signal, where the control signaling includes an indication of the source reference signal from a set of multiple source reference signals that are quasi co-located with a set of multiple DMRSs, means for determining the differential measurement for the source reference signal based on measuring a DMRS that is quasi co-located with the source reference signal, where the differential measurement is determined with reference to a most recently reported beam measurement for the source reference signal, and means for transmitting, to the first network entity, a second report indicating the differential measurement for the source reference signal.

A non-transitory computer-readable medium storing code for wireless communications at a UE is described. The code may include instructions executable by a processor to transmit, to a first network entity, a first report indicating a measurement for a first beam based on a source reference signal, receive control signaling configuring the UE to report a differential measurement for the source reference signal, where the control signaling includes an indication of the source reference signal from a set of multiple source reference signals that are quasi co-located with a set of multiple DMRSs, determine the differential measurement for the source reference signal based on measuring a DMRS that is quasi co-located with the source reference signal, where the differential measurement is determined with reference to a most recently reported beam measurement for the source reference signal, and transmit, to the first network entity, a second report indicating the differential measurement for the source reference signal.

Some examples of the method, apparatuses, and non-transitory computer-readable medium described herein may further include operations, features, means, or instructions for receiving the DMRS on a downlink shared channel that may be quasi co-located with the source reference signal.

In some examples of the method, apparatuses, and non-transitory computer-readable medium described herein, determining the differential measurement may include operations, features, means, or instructions for determining the differential measurement from the DMRS based on the DMRS being associated with a transmission configuration indicator state of the source reference signal.

In some examples of the method, apparatuses, and non-transitory computer-readable medium described herein, the indication of the source reference signal includes a transmission configuration indicator state associated with the source reference signal, a reference signal identifier for the source reference signal, or both.

In some examples of the method, apparatuses, and non-transitory computer-readable medium described herein, the reference signal identifier may be a synchronization signal block (SSB) resource identifier (SSBRI) or a CSI reference signal (CSI-RS) resource identifier (CRI).

In some examples of the method, apparatuses, and non-transitory computer-readable medium described herein, the downlink shared channel may be a semi-persistent scheduling downlink shared channel.

Some examples of the method, apparatuses, and non-transitory computer-readable medium described herein may further include operations, features, means, or instructions for receiving the DMRS on a downlink control channel with a frequency domain precoder cycling, where the downlink control channel may be quasi co-located with the source reference signal.

In some examples of the method, apparatuses, and non-transitory computer-readable medium described herein, receiving the DMRS may include operations, features, means, or instructions for receiving the DMRS in one or more resource element groups associated with the source reference signal based on the indication of the source reference signal.

In some examples of the method, apparatuses, and non-transitory computer-readable medium described herein, the indication of the source reference signal includes a transmission configuration indicator state associated with the source reference signal, a reference signal identifier for the source reference signal, a group of resource element groups, or any combination thereof.

Some examples of the method, apparatuses, and non-transitory computer-readable medium described herein may further include operations, features, means, or instructions for receiving the DMRS on a downlink control channel with a time domain precoder cycling, where the downlink control channel may be quasi co-located with the source reference signal.

In some examples of the method, apparatuses, and non-transitory computer-readable medium described herein, receiving the DMRS may include operations, features, means, or instructions for receiving the DMRS in a monitoring occasion associated with the source reference signal, a search space associated with the source reference signal, a control resource set associated with the source reference signal, or any combination thereof, based on the indication of the source reference signal.

In some examples of the method, apparatuses, and non-transitory computer-readable medium described herein, the indication of the source reference signal includes a transmission configuration indicator state associated with the source reference signal, a reference signal identifier for the source reference signal, one or more downlink control channel monitoring occasion identifiers associated with a set of downlink control channel repetitions, one or more downlink control channel search space identifier associated with a set of downlink control channel repetitions, or any combination thereof.

Some examples of the method, apparatuses, and non-transitory computer-readable medium described herein may further include operations, features, means, or instructions for determining a second differential measurement for the source reference signal based on measuring a second DMRS of the set of multiple DMRSs and transmitting, to network entity, a third report indicating the second differential measurement for the source reference signal.

Some examples of the method, apparatuses, and non-transitory computer-readable medium described herein may further include operations, features, means, or instructions for receiving a control message configuring resources for a CSI report corresponding, the resources corresponding to a periodicity of a semi-periodic scheduling downlink shared channel resource carrying the set of multiple DMRSs, where the second report may be a first CSI report, and the third report may be a second CSI report.

In some examples of the method, apparatuses, and non-transitory computer-readable medium described herein, transmitting the second report may include operations, features, means, or instructions for transmitting a CSI report indicating the differential measurement.

Some examples of the method, apparatuses, and non-transitory computer-readable medium described herein may further include operations, features, means, or instructions for receiving, from network entity, a control message disabling reporting differential measurements for the source reference signal.

In some examples of the method, apparatuses, and non-transitory computer-readable medium described herein, the control message may be received via a medium access control element or downlink control information, or both.

In some examples of the method, apparatuses, and non-transitory computer-readable medium described herein, the set of multiple source reference signals may be transmitted by a set of multiple transmission reception points, the first network entity corresponding to a first transmission reception point of the set of multiple transmission reception points.

In some examples of the method, apparatuses, and non-transitory computer-readable medium described herein, the differential measurement may be a differential reference signal received power measurement, a differential channel quality indicator measurement, or both, with reference to the measurement for the first beam.

A method for wireless communications at a network entity is described. The method may include receiving a first report indicating a measurement for a first beam based on a source reference signal, transmitting control signaling configuring a UE to report a differential measurement for the source reference signal, where the control signaling includes an indication of the source reference signal from a set of multiple source reference signals that are quasi co-located with a set of multiple DMRSs, and receiving a second report indicating the differential measurement for the source reference signal based on a DMRS that is quasi co-located with the source reference signal, where the differential measurement is with reference to a most recently reported beam measurement for the source reference signal.

An apparatus for wireless communications at a network entity is described. The apparatus may include a processor, memory coupled with the processor, and instructions stored in the memory. The instructions may be executable by the processor to cause the apparatus to receive a first report indicating a measurement for a first beam based on a source reference signal, transmit control signaling configuring a UE to report a differential measurement for the source reference signal, where the control signaling includes an indication of the source reference signal from a set of multiple source reference signals that are quasi co-located with a set of multiple DMRSs, and receive a second report indicating the differential measurement for the source reference signal based on a DMRS that is quasi co-located with the source reference signal, where the differential measurement is with reference to a most recently reported beam measurement for the source reference signal.

Another apparatus for wireless communications at a network entity is described. The apparatus may include means for receiving a first report indicating a measurement for a first beam based on a source reference signal, means for transmitting control signaling configuring a UE to report a differential measurement for the source reference signal, where the control signaling includes an indication of the source reference signal from a set of multiple source reference signals that are quasi co-located with a set of multiple DMRSs, and means for receiving a second report indicating the differential measurement for the source reference signal based on a DMRS that is quasi co-located with the source reference signal, where the differential measurement is with reference to a most recently reported beam measurement for the source reference signal.

A non-transitory computer-readable medium storing code for wireless communications at a network entity is described. The code may include instructions executable by a processor to receive a first report indicating a measurement for a first beam based on a source reference signal, transmit control signaling configuring a UE to report a differential measurement for the source reference signal, where the control signaling includes an indication of the source reference signal from a set of multiple source reference signals that are quasi co-located with a set of multiple DMRSs, and receive a second report indicating the differential measurement for the source reference signal based on a DMRS that is quasi co-located with the source reference signal, where the differential measurement is with reference to a most recently reported beam measurement for the source reference signal.

Some examples of the method, apparatuses, and non-transitory computer-readable medium described herein may further include operations, features, means, or instructions for transmitting the DMRS on a downlink shared channel that may be quasi co-located with the source reference signal.

Some examples of the method, apparatuses, and non-transitory computer-readable medium described herein may further include operations, features, means, or instructions for transmitting the DMRS on a downlink control channel with a frequency domain precoder cycling, where the downlink control channel may be quasi co-located with the source reference signal.

In some examples of the method, apparatuses, and non-transitory computer-readable medium described herein, transmitting the DMRS may include operations, features, means, or instructions for transmitting the DMRS in one or more resource element groups associated with the source reference signal based on the indication of the source reference signal.

Some examples of the method, apparatuses, and non-transitory computer-readable medium described herein may further include operations, features, means, or instructions for transmitting the DMRS on a downlink control channel with a time domain precoder cycling, where the downlink control channel may be quasi co-located with the source reference signal.

Some examples of the method, apparatuses, and non-transitory computer-readable medium described herein may further include operations, features, means, or instructions for receiving a third report indicating a second differential measurement for the source reference signal based on a second DMRS quasi co-located with a second source reference signal of the set of multiple source reference signals.

Some examples of the method, apparatuses, and non-transitory computer-readable medium described herein may further include operations, features, means, or instructions for transmitting a control message disabling reporting differential measurements for the source reference signal.

In some examples of the method, apparatuses, and non-transitory computer-readable medium described herein, the network entity corresponds to a first transmission reception point of a set of multiple transmission reception points.

In some examples of the method, apparatuses, and non-transitory computer-readable medium described herein, the differential measurement may be a differential reference signal received power measurement, a differential channel quality indicator measurement, or both, with reference to the measurement for the first beam.

### BRIEF DESCRIPTION OF THE DRAWINGS

FIG. 1 illustrates an example of a wireless communications system that supports explicit and implicit precoder indication for demodulation reference signal (DMRS)-based channel state information (CSI) reporting in accordance with one or more aspects of the present disclosure.

FIG. 2 illustrates an example of a wireless communications system that supports explicit and implicit precoder indication for DMRS-based CSI reporting in accordance with one or more aspects of the present disclosure.

FIG. 3 illustrates an example of a wireless communications system that supports explicit and implicit precoder indication for DMRS-based CSI reporting in accordance with one or more aspects of the present disclosure.

FIG. 4 illustrates an example of a differential beam quality reporting scheme that supports explicit and implicit precoder indication for DMRS-based CSI reporting in accordance with one or more aspects of the present disclosure.

FIG. 5 illustrates an example of a process flow that supports explicit and implicit precoder indication for DMRS-based CSI reporting in accordance with one or more aspects of the present disclosure.

FIGS. 6 and 7 show block diagrams of devices that support explicit and implicit precoder indication for DMRS-based CSI reporting in accordance with one or more aspects of the present disclosure.

FIG. 8 shows a block diagram of a communications manager that supports explicit and implicit precoder indication for DMRS-based CSI reporting in accordance with one or more aspects of the present disclosure.

FIG. 9 shows a diagram of a system including a device that supports explicit and implicit precoder indication for DMRS-based CSI reporting in accordance with one or more aspects of the present disclosure.

FIGS. 10 and 11 show block diagrams of devices that support explicit and implicit precoder indication for DMRS-based CSI reporting in accordance with one or more aspects of the present disclosure.

FIG. 12 shows a block diagram of a communications manager that supports explicit and implicit precoder indication for DMRS-based CSI reporting in accordance with one or more aspects of the present disclosure.

FIG. 13 shows a diagram of a system including a device that supports explicit and implicit precoder indication for DMRS-based CSI reporting in accordance with one or more aspects of the present disclosure.

FIGS. 14 and 15 show flowcharts illustrating methods that support explicit and implicit precoder indication for DMRS-based CSI reporting in accordance with one or more aspects of the present disclosure.

### DETAILED DESCRIPTION

Some wireless systems may implement a hierarchical beam refinement procedure for a user equipment (UE) and a network entity to perform beam selection. For example, to select a wide beam pair, a network entity may perform synchronization signal block (SSB) beam sweeping by periodically transmitting SSBs in different beam directions. A UE may receive and measure the SSBs using different UE beams and may select a beam pair for communication between the UE and the network entity. Some wireless systems may then perform a channel state information (CSI) reference signal (CSI-RS) beam sweep to refine the wide beam pair selected from the SSB beam sweep and to select a narrow beam pair. For example, the network entity may transmit CSI-RS using narrow network entity beams based on the wide beam pair, and the UE may measure the CSI-RS using narrow UE beams. The UE may then transmit a CSI report for the received CSI-RS to perform beam management for the narrow beams and select a narrow beam pair based on the beam management for the narrow beams.

In some examples, the hierarchical beam refine procedure may implement a longer periodicity, as some scenarios (e.g., low-speed or stationary scenarios) may result in a few beam index changes over long durations of time. As such, some systems may implement a longer periodicity for reporting measurements for wide or narrow beam management, or both. In some cases, the UE may perform beam estimation to predict a best beam between the longer periodicity beam reports. For example, the UE may estimate a strongest SSB resource block indicator at a later time, a strongest CSI-RS resource indicator (CRI) at a later time, or reference signal received power (RSRP) measurements for future synchronization signal block reference indicators (SSBRIs) and CRIs, among other estimations or predictions. The UE may then rank beams based on the estimates and select a beam to use based on the ranking without performing the high overhead signaling of frequent beam management reporting. However, beam prediction may lead to some uncertainty of the predicted beams. To alleviate uncertainty for the predicted beams, the UE may perform intermediate beam refinement. For example, the UE may report differential beam quality information between beam management reports instead of transmitting a full beam management report, which may result in significant overhead.

In some examples, the UE may determine differential beam qualities based on source reference signals transmitted by the network entity, and the UE may report the differential beam qualities to the network entity. Reporting the differential qualities instead of performing a full beam sweep may enable the network entity to refine the predicted beams with reduced overhead. The UE may report differential qualities, such as a differential RSRP, based on demodulation reference signals (DMRS) received in control channels or shared channels. For example, the UE may measure DMRS quasi co-located with a beam and report a differential RSRP with respect to a latest or most recent RSRP measurement for that beam. However, if the DMRS are quasi co-located with multiple beams (e.g., in a multiple transmission and reception point (mTRP) configuration), the UE may be unable to identify which DMRS to use to calculate the differential beam quality information.

To enable a UE to identify DMRS for deriving differential beam qualities, a network entity may explicitly indicate a source reference signal for DMRSs to the UE. DMRS may be multiplexed with source reference signals in the frequency domain, time domain, spatial domain, or any combination thereof. The network entity may indicate a source reference signal for DMRSs that are transmitted on a physical downlink shared channel (PDSCH), a physical downlink control channel (PDCCH), or both. For example, the network entity may indicate which reference signals (e.g., which DMRS) may be used for differential RSRP reporting. The network entity may indicate a source reference signal for a DMRS transmitted on the PDSCH, such as by indicating transmission configuration indication (TCI) state of the source reference signal or by indicating a reference signal identifier of the source reference signal.

The UE may then calculate the differential measurements or differential beam quality information by measuring PDSCH DMRS that are associated with the indicated TCI state or that are quasi co-located with the indicated source reference signal. Additionally, the UE may report the differential measurements or differential beam quality information to the network entity. The network entity may then use the differential measurements or differential beam quality information to refine the beam prediction. In some examples, a UE may report a differential beam measurement for the first source reference signal based on any received DMRS, and the network entity may determine how to use these additional differential beam measurements to refine predicted beams. In some examples, a UE may not expect to report a differential beam measurement associated with a source reference signal. For example, the network entity may enable or disable reporting differential measurements for the source reference signal.

Such implementations of the subject matter described in this disclosure also can be implemented to realize one or more of the following potential advantages. For example, in accordance with specifying a source reference signal for a differential beam measurement, the UE and the network entity may reduce CSI reporting overhead while performing beam management and maintenance to use a strongest beam between CSI reports with a longer periodicity. These techniques may be implemented to enable a UE to identify DMRS to use to obtain the differential measurement when DMRS are quasi co-located with multiple source reference signals, enabling reliable channel characteristic measurements for beams used by the UE and the network entity with lower power usage and overhead compared to full beam reports.

Aspects of the disclosure are initially described in the context of wireless communications systems. Aspects of the disclosure are further illustrated by and described with reference to apparatus diagrams, system diagrams, and flowcharts that relate to explicit and implicit precoder indication for DMRS-based CSI reporting.

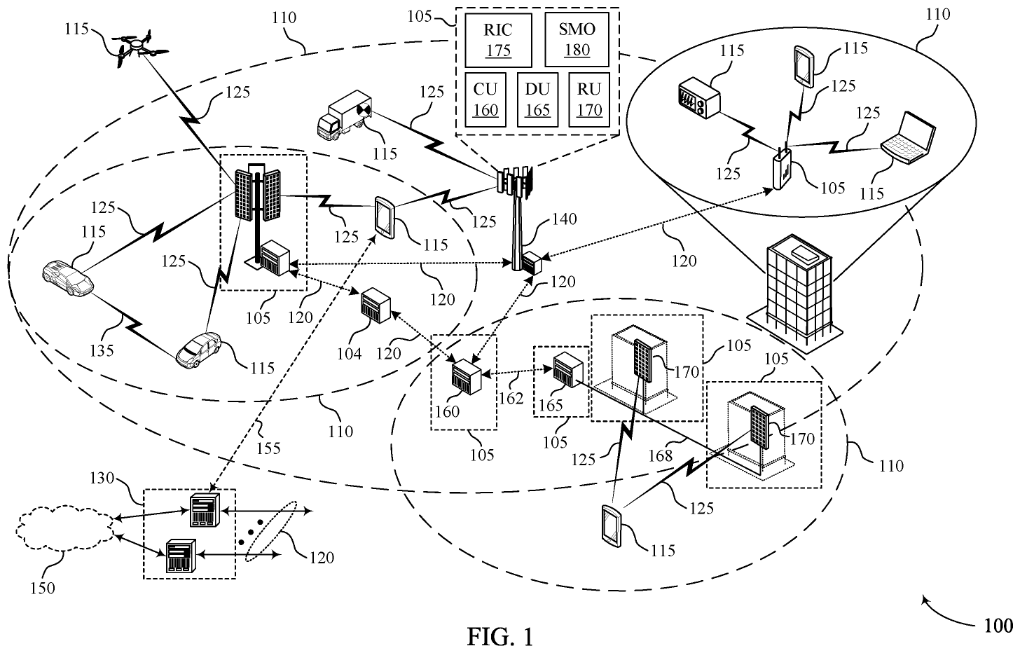

FIG. 1 illustrates an example of a wireless communications system 100 that supports explicit and implicit precoder indication for DMRS-based CSI reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support explicit and implicit precoder indication for DMRS-based CSI reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

Wireless communications system 100 may implement a hierarchical beam refinement procedure for a UE 115 and a network entity 105 to communicate. For example, the UE 115 may perform an initial access procedure, such as SSB beam sweeping, to acquire uplink synchronization and random access channel (RACH) association in communication with the network entity. SSB beam sweeping may include selecting a wide beam (e.g., layer one (L1) beam) pair for communication by periodically transmitting SSBs in different beam directions. In this example, the UE 115 may measure the SSBs using different wide UE beams and may select the wide beam pair (e.g., including a wide UE beam and a wide network entity beam) for communication between the UE 115 and the network entity 105 based on the measurements. The selected wide beam pair may enable communication between the UE 115 and the network entity 105, resulting in the UE 115 performing further wireless communication procedures in connected mode.

Additionally or alternatively, within the connected mode, wireless communications system 100 may support the UE 115 performing a CSI-RS beam sweep to refine the wide beam pair selected from the SSB beam sweep and to select a narrow beam pair. For example, the network entity 105 may transmit CSI-RS using narrow network entity beams based on the selected wide beam pair, and the UE 115 may measure the CSI-RS using narrow UE beams. The UE 115 may then transmit a CSI report for the received CSI-RS to perform beam management for the narrow beams and select a narrow beam pair for wireless communication. The UE 115 may select the narrow beam pair based on a top beam index. As such, hierarchical beam refinement may decrease the chances of beam failure and result in a faster beam failure recovery (BFR) by selecting a narrow beam pair with a stable connection between the UE 115 and the network entity 105. The decreased chances of beam failure and faster recovery may result in ultimately avoiding radio link failure (RLF) between the UE 115 and the network entity 105.

In some cases, performing the beam refinement procedure may use significant overhead, such as available resources and power. For example, the UE 115 may perform frequent beam management reporting every 20 ms, which may result in significant power consumption. However, in some cases, such as low mobility cases, the top beam index may not change over a long duration of time. As such, UEs 115 in some systems may perform beam management, or report information for beam management (e.g., wide beam management or narrow beam management, or both), with an increased periodicity of 80 ms. The increased periodicity may be based on an absolute time domain interval between top beam index change instances. In some cases, the UE 115 may predict a strongest beam (e.g., top beam) at a future time to support the lower rate and increased periodicity of high-level beam management. The UE 115 may initially predict the top beam index every 80 ms, and at a future time, the UE 115 may decrease the periodicity for top beam selection to 20 ms to predict the strongest beam.

For example, the UE 115 may estimate a strongest SSBRI at a later time, a strongest CRI at a later time, RSRP measurement values for future SSBRIs and CRIs, possibilities of each of the future SSBRIs and CRIs being the strongest beam (e.g., via softmax output), mean and variance values for future SSBRIs and CRI, or a combination thereof. Additionally or alternatively, the UE 115 may perform artificial intelligence (AI) based beam prediction, which may include using a convolutional neural network, a recurrent neural network, long short-term memory, or a combination thereof.

The UE 115 may then rank beams based on the predictions and select the strongest beams to use based on the ranking, without performing the initial high overhead signaling of frequent beam management reporting. However, these predictions may result in some uncertainty of the selected strongest beams. To alleviate uncertainty for the predicted beams, the UE 115 may perform intermediate refinement by performing L1 RSRP measurement reporting to determine differential beam qualities. L1 RSRP measurement reporting may measure a received power of wide beams. However, performing L1 RSRP measurements may have significant overhead and use a large amount of power.

Alternatively, the UE 115 may determine differential beam qualities by measuring DMRSs received on downlink control channels or shared channels. The UE 115 may report the differential beam qualities to the network entity. Reporting the differential qualities instead of performing a high-level beam sweep may enable the network entity to refine the predicted beams with reduced power usage and overhead. However, the DMRSs may be quasi co-located with multiple source reference signals at the network entity 105, such as in a frequency domain scenario (e.g., frequency domain precoder cycling for a control channel), or in a time domain scenario (e.g. an mTRP scenario or URLLC). For example, multiple network entities 105 may transmit DMRSs to the UE 115. The DMRSs may be quasi co-located with multiple source reference signals (e.g., SSB #3 and SSB #6) at the network entities 105. Therefore, the UE 115 may be unable to identify which DMRSs to use in order to derive the differential beam qualities.

Wireless communications system 100 may support enabling a UE 115 to identify DMRSs for deriving differential beam qualities based on source reference signals. For example, a UE 115 may transmit a first report indicating a beam measurement to a network entity 105 based at least in part on a source reference signal. The UE 115 may receive control signaling configuration from the network entity 105 to report a differential measurement for the source reference signal. The control signaling may include an indication of the source reference signal from multiple source reference signals that are quasi co-located with a plurality of DMRSs. In some examples, the UE 115 may receive the DMRSs on a downlink shared channel that is quasi co-located with the source reference signal.

The UE 115 may then determine the differential measurement for the source reference signal based on measuring an indicated DMRS that is quasi co-located with the source reference signal. In some examples, the UE 115 may determine the differential measurement based on the indicated DMRS being associated with a transmission configuration indicator (TCI) state of the source reference signal. The UE 115 may then transmit a second report indicating the differential measurement for the second source reference signal to the network entity 105.

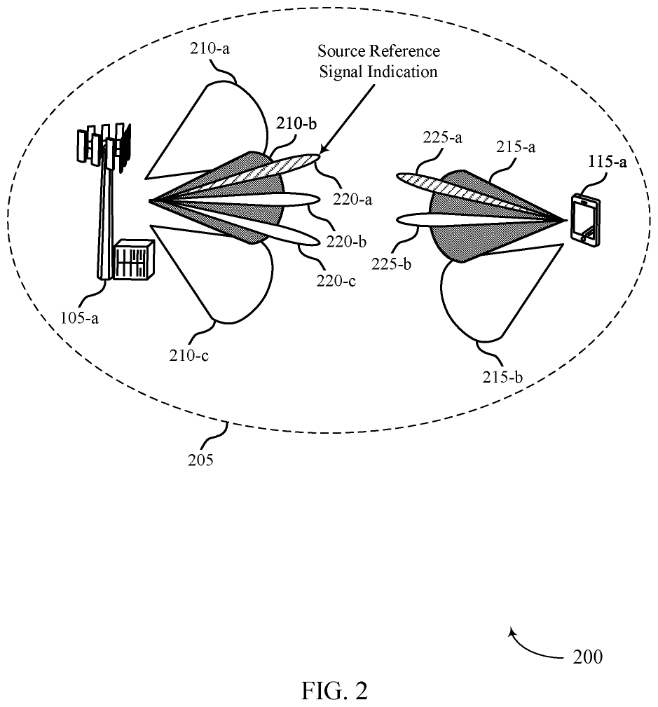

FIG. 2 illustrates an example of a wireless communications system 200 that supports explicit and implicit precoder indication for DMRS-based CSI reporting in accordance with one or more aspects of the present disclosure. In some examples, wireless communications system 200 may implement aspects of wireless communications system 100. For example, wireless communications system 200 includes a network entity 105-a and a UE 115-a in a wireless range 205, which may be examples of the corresponding devices described with reference to FIG. 1.

Wireless communications system 200 may implement a hierarchical beam refinement procedure for a UE 115-a and a network entity 105-a to communicate. For example, the UE 115-a may perform SSB beam sweeping to select a wide beam pair for communication by periodically transmitting SSBs in different beam directions. Wide beams 210, including wide beam 210-a, wide beam 210-b, and wide beam 210-c may be associated with the network entity 105-a. Wide beams 215, including wide beam 215-a and wide beam 215-b may be associated with the UE 115-a. In this example, the UE 115-a may receive and measure the SSBs using wide beams 215 and select the wide beam pair (e.g., wide beam 210-b and a wide beam 215-b) for communications between the UE 115-a and the network entity 105-a.

Additionally or alternatively, wireless communications system 200 may support the UE 115-a performing a CSI-RS beam sweep to refine the wide beam pair (e.g., wide beam 210-b and a wide beam 215-b) selected from the SSB beam sweep. For example, the network entity 105-a may transmit CSI-RS using narrow network entity beams based on the selected wide beam pair, and the UE 115-a may measure the CSI-RS using narrow UE beams. Narrow beams 220, including narrow beam 220-a, narrow beam 220-b, and narrow beam 220-c, may be associated with the network entity 105. Narrow beams 225, including narrow beam 225-a and narrow beam 225-b, may be associated with the UE 115-a. The UE 115-a may then transmit a CSI report for the received CSI-RS to perform beam management for the narrow beams 225 and select a narrow beam pair (e.g., narrow beam 220-a and narrow beam 225-a) for wireless communication. The UE 115-a may select the narrow beam pair based on a top beam index, which may decrease the chances of beam failure and result in faster BFR by selecting a narrow beam pair with a stable connection between the UE 115-a and the network entity 105-a.

In some examples, performing the beam refinement procedure may use significant overhead. For example, the UE 115-a may perform frequent beam management reporting, which may result in significant power consumption. However, in some cases, such as low mobility cases, the top beam index may not change over a long duration of time, and the UE 115-a may perform beam management with an increased periodicity. In some cases, the UE 115-a may predict a strongest beam at a future time to support the lower rate and increased periodicity of high-level beam management.

The UE 115-a may rank beams based on the strongest beam predictions and select the strongest beams to use based on the ranking, without performing the initial high overhead signaling of frequent beam management reporting. However, these predictions may result in some uncertainty of the selected strongest beams. To alleviate uncertainty for the predicted beams, the UE 115-a may perform intermediate refinement by performing L1 RSRP measurement reporting to determine differential beam qualities. However, performing L1 RSRP measurements may have significant overhead and use a large amount of power. Alternatively, the UE 115-a may determine differential beam qualities by measuring DMRSs on PUCCH, PUSCH, or both. Network entity 105-a may transmit DMRSs to UE 115-a using wide beams 210.

The UE 115-a may report the differential beam qualities to the network entity 105-a, which may enable the network entity 105-a to refine the predicted beams with reduced power usage and overhead. However, DMRSs may be quasi co-located multiple source reference signals at the network entity 105. For example, one or more network entities 105 may transmit DMRSs to the UE 115-a. The DMRSs may be quasi co-located with multiple source reference signals (e.g., SSB #3 and SSB #6). Therefore, the UE 115-a may be unable to identify which DMRSs to use in order to derive the differential beam qualities.

Wireless communications system 200 may support a UE 115-a to identify DMRSs for deriving differential beam qualities based on source reference signals. For example, a UE 115-a may transmit a first report indicating the beam measurement to the network entity 105-a based at least in part on a source reference signal. The UE 115 may receive control signaling configuration from the network entity 105-a to report a differential measurement for the source reference signal. In some examples, the network entity 105-a may transmit the control signaling configuration as a MAC control element (CE), downlink control information, RRC signaling, or any combination thereof. In some examples, the UE 115-a may be RRC configured or MAC-CE/DCI indicated by the network entity 105-a, to report a differential L1-RSRP/CQI associated with a further explicitly indicated first Type-D QCL source reference signal, wherein: the first Type-D QCL source reference signal is one of the multiple Type-D QCL source reference signals associated with a PDSCH or PDCCH received by the UE; and the differential reporting is referred to a recently reported L1-RSRP/CQI associated with the first Type-D QCL source reference signal. In some examples, such as when the network entity 105-b transmits the control signaling configuration as downlink control information, the downlink control information may be based on dedicated lists or based on a CSI triggering lists configuration.

The control signaling may be communicated by the network entity 105-a and the UE 115-a using the narrow beam pair (e.g., narrow beam 220-a and narrow beam 225-a). The control signaling may include an indication of the source reference signal from multiple source reference signals that are quasi co-located with the DMRSs. In some examples, the indication included in the control signaling configuration may indicate a source reference signal for DMRS that are transmitted on PUSCH, PUCCH, or both. For example, the network entity 105-a may transmit the source reference signal indication using narrow beam 220-a. The UE 115 may then receive the DMRS using narrow beam 225-a, such as on a downlink shared channel that is quasi co-located with the source reference signal. The network entity may transmit the control signaling indicating the source reference signal, enabling the UE 115-a to identify which reference signals (e.g., which DMRS) may be used for differential RSRP reporting.

The network entity 105-a may indicate a source reference signal for a DMRS transmitted on a PDSCH by indicating the TCJ state of the source reference signal or by indicating a reference signal identifier of a source reference signal. In another example, the network entity 105 may indicate a source reference signal for DMRS transmitted on a PDCCH by indicating a TCI state or a reference signal identifier (e.g., SSBRI or CRI) and a group of resource element groups (REGs). Additionally or alternatively, the network entity 105 may indicate a source reference signal for the DMRS transmitted on a PDCCH by indicating a TCI state, a reference signal identifier (e.g., SSBRI or CRI), a number of PDCCH monitoring occasion identifiers associated with a set of downlink control channel repetitions, a number of PDCCH search space identifiers associated with a set of PDCCH repetitions, a number of control resource set identifiers associated with a set of PDCCH repetitions, or any combination thereof.

In some examples, the control signaling configuration may indicate for the UE 115-a to calculate the differential L1-RSRP, channel quality information (CQI), or both, associated with the indicated source reference signal. The UE 115-a may then determine the differential beam quality with reference to a recently reported RSRP measurement or CQI associated with the first source reference signal. In some examples, the UE 115-a may include the PDSCH DMRSs that are associated with the indicated TCI state or quasi co-located with the indicated source reference signal. In some examples, such as mTRP scenarios, the PDSCH DMRS may be quasi co-located with different SSBs. In some examples, the network entity 105-a may use precoder cycling for SPS PDSCH, wherein the respective PDSCHs are quasi co-located with different source reference signals in different PDSCH occasions (e.g., also SSB #3 & SSB #5).

In another example, the UE 115-a may calculate the differential L1-RSRP measurements, CQI, or both, based on the PDCCH DMRS comprised by the indicated group of REGs. The differential L1-RSRP measurement, CQI, or both, may be based on the indicated source reference signal. In some examples, a control resource set may be quasi co-located with two different source reference signals. In this example, the network entity may indicate one of the two source reference signals for a PDCCH DMRS. The UE 115-a may then report the differential measurement associated with the indicated first source reference signal to the network entity 105-a using the narrow beam 225-a. In some examples, the differential measurement may be with reference to a last or latest reported measurement, such as an absolute measurement included in the first report. In some cases, the differential measurement may be determine with reference to a most recently reported absolute measurement for the source reference signal, such as an absolute RSRP or CQI measurement for the source reference signal.

For example, the differential measurement may be determined based on a change to absolute measurement, such as a change in an RSRP or CQI. For example, the UE 115-a may determine an absolute RSRP measurement, and the differential measurement may be determined based on a difference between the absolute RSRP measurement and an RSRP measurement of a DMRS.

In some examples, the UE 115-a may calculate the differential L1-RSRP, CQI, or both, based on the indicated source reference signal and/or the PDCCH monitoring occasions, search spaces, or control resource sets. In some examples, different PDCCH repetition occasions may be associated with different source reference signals. In this case, the UE 115 may then transmit multiple reports indicating the differential measurement (e.g., the differential L1-RSRP measurement, CQI, or both) for the multiple reference signals.

The network entity 105-a may use the differential measurement to efficiently refine the beam prediction with less overhead. For example, the network entity 105-a may determine an absolute measurement for the DMRS based on a differential difference. The differential difference may be a difference between a measurement included in the first report received from the UE 115-a and the differential measurement based on the DMRS. The network entity 105-a may then use the absolute measurement to determine the strongest beam for wireless communication between the UE 115-a and the network entity 105-a. In some examples, the network entity 105-a may update a beam at the network entity 105-a or the UE 115-a, or both, based on the differential measurement.

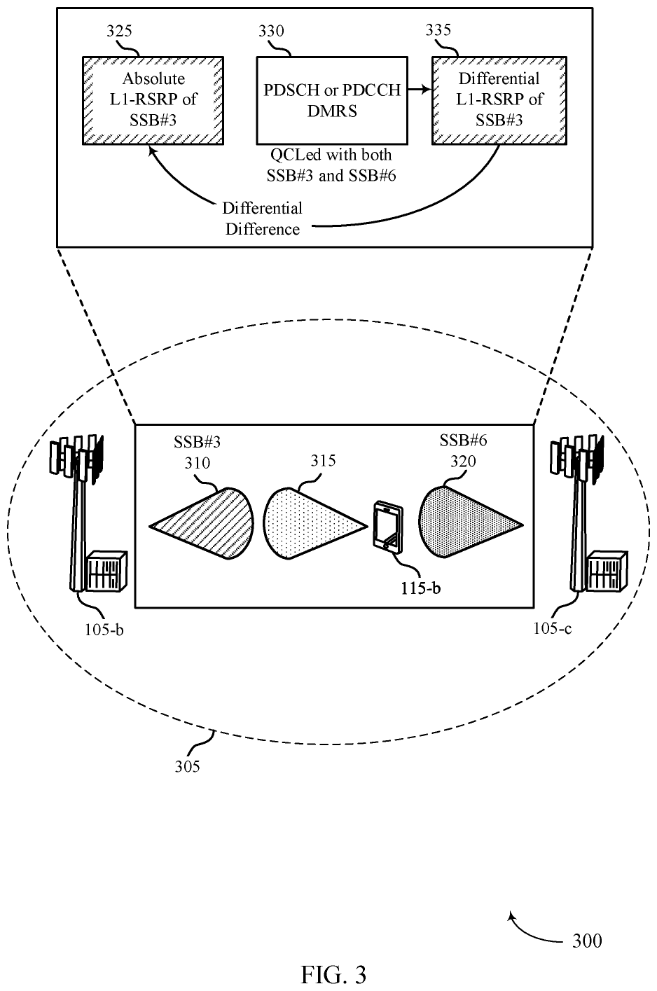

FIG. 3 illustrates an example of a wireless communications system 300 that supports explicit and implicit precoder indication for DMRS-based CSI reporting in accordance with one or more aspects of the present disclosure. In some examples, wireless communications system 300 may implement aspects of wireless communications system 100. For example, wireless communications system 300 may include one or more network entities 105, such as a network entity 105-b and a network entity 105-c. In some examples, the network entity 105-b and the network entity 105-c may be examples of TRPs of a network entity 105 in an mTRP configuration. The wireless communications system may include a UE 115-b, which may be an example of a UE 115 as described with reference to FIGS. 1 and 2. The UE 115-b, the network entity 105-b, or the network entity 105-c, or any combination thereof, may communicate within a coverage area 305.

In some cases, a UE 115-b may perform beam management with an increased periodicity. In some cases, the UE 115-b may predict a strongest beam at a future time to support the lower rate and increased periodicity of high-level beam management. The UE 115-b may rank beams based on the strongest beam predictions and select a strongest beam pair to use based on the ranking. However, these predictions may result in some uncertainty of the selected strongest beams. To alleviate uncertainty for the predicted beams, the UE 115-b may perform intermediate refinement by performing L1 RSRP measurement reporting to determine differential beam qualities. However, performing L1 RSRP measurements may have significant overhead and use a large amount of power.

To reduce uncertainty from beam prediction, the UE 115-b may determine differential beam qualities by measuring DMRSs 330 received on PDSCH, PDCCH, or both. However, the DMRS 330 may be quasi co-located multiple source reference signals. For example, a network entity 105-b and 105-c may transmit PDSCH or PDCCH DMRS to the UE 115. PDSCH or PDCCH DMRS may be quasi co-located with multiple source reference signals (e.g., SSB #3 and SSB #6). Therefore, the UE 115-a may be unable to identify which DMRSs to use in order to derive the differential beam qualities.

Wireless communications system 300 may support enabling a UE 115 to identify DMRS for deriving differential beam qualities based on source reference signals. For example, the UE 115-b may receive control signaling from the network entity 105-b, configuring the UE 115-b to report a differential measurement associated with a source reference signal. The control signaling may include an indication of the source reference signal from multiple source reference signals that are quasi co-located with the PDSCH or PDCCH carrying DMRS.

For example, the UE may receive DMRSs 330 transmitted by the network entity 105-b and the network entity 105-c. In some examples, the network entity 105-b and the network entity 105-c may be example of TRPs of an mTRP configuration. The DMRS 330 transmitted by network entity 105-b may be quasi co-located with SSB #3 and may be associated with wide beam 310. Additionally, the DMRS 330 transmitted by network entity 105-c may be quasi co-located with SSB #6 and may be associated with wide beam 320. Therefore, the DMRS 330 may be quasi co-located with both SSB #3 and SSB #6. The UE 115-b may then determine differential beam qualities associate with SSB #3 based on source reference signals associated with SSB #3 and SSB #6.

In some examples, the DMRS 330 may be transmitted on PDSCH and may be quasi co-located with multiple source reference signals from different TRPs, such as in an mTRP configuration. For example, PDSCH carrying the DMRS 330 may be quasi co-located with SSB #3 310, transmitted by the network entity 105-b, and SSB #6 320, transmitted by the network entity 105-c. The UE 115-b may receive an indication to report a differential measurement associated with one of the source reference signals. For example, the network entity 105-b may indicate the SSB #3 310 by indicating a TCI state associated with the SSB #3 310 or by indicating a reference signal identifier (e.g., SSBRI or CRI) for the SSB #3 310, or both. The UE 115-b may use the PDSCH DMRS that is quasi co-located with SSB #3 310 to calculate the differential measurement 335 (e.g., the differential L1-RSRP of SSB #3). The differential measurement 335 may be based on the PDSCH DMRS associated with the indicated TCI state or the PDSCH DMRS quasi co-located with the indicated reference signal. In some cases, the PDSCH may be a PDSCH for an mTRP configuration or an SPS PDSCH with time domain precoder cycling, or both. In the case of the mTRP configuration, the PDSCH DMRS may be quasi co-located with two different SSBs, such as SSB #3 310 and SSB #6 320. In the case of the SPS PDSCH with time domain precoder cycling, the network entity 105-b may use precoder cycling for SPS PDSCH. In this case, the PDSCH DMRSs may be quasi co-located with different source reference signals in different PDSCH occasions, such as SSB #3 310 and SSB #6 320.

The UE may then use the PDSCH or PDCCH DMRS 330 to determine a differential measurement of the source reference signal, such as a differential RSRP measurement or a differential CQI measurement. The differential L1-RSRP of SSB #3 may be determined with reference to an absolute measurement, such as an absolute measurement 325. The absolute measurement 325 may be a previous, most recent, or latest absolute measurement for the source reference signal or a beam associated with the source reference signal, such as SSB #3 310. The differential measurement may, in some cases, be a difference between a measurement included in the first report received from the UE 115-b and a measurement taken based on the DMRS 330.

The UE 115-b may report the differential measurement 335 to the network entity 105-b using wide beam 315. In some examples, the network entity 105-b may use the reported differential measurement to calculate or update an absolute measurement of the source reference signal or a beam corresponding to the source reference signal. The network entity 105-b may then determine the strongest beam for wireless communication between the UE 115-b and the network entity 105-b based on the reported differential measurement.

In some cases, the DMRS may be transmitted on PDCCH. For example, the network entity 105-b and the network entity 105-c may transmit DMRS on PDCCH resources using a frequency domain precoder cycling. In this case, the network entity 105-b may indicate a source reference signal for the DMRS on the PDCCH by indicating a TCI state, a reference signal identifier (e.g., SSBRI or CRI), a group of REGs, or any combination thereof. For example, the UE 115-b may identify the DMRS 330 for determining the differential measurement based on the DMRS 330 being quasi co-located with a source reference signal corresponding to the indicated reference signal identifier. Additionally, or alternatively, the UE 115-b may identify the DMRS 330 based on the DMRS 330 being configured for, or being associated with, the indicated TCI state. Additionally, or alternatively, the UE 115-b may calculate the differential measurement on the DMRS 330 transmitted on the indicated group of REGs and derive the differential value or differential measurement based on the indicated source reference signal.

In some examples, the DMRS 330 may be transmitted on PDCCH with a time domain precoder cycling with PDCCH repetitions. For example, the network entity 105-b may indicate a source reference signal for the DMRS 330 transmitted on a PDCCH with a time domain precoder cycling and PDCCH repetition by indicating one or more of a TCI-state, a reference signal identifier (SSBRI or CRI), one or more downlink control channel monitoring occasion identifiers associated with a set of downlink control channel repetitions, one or more downlink control channel search space identifiers associated with a set of downlink control channel repetitions, one or more control resource set identifiers associated with a set of downlink control channel repetitions, or any combination thereof. The UE 115-b may calculate a differential measurement (e.g., a differential Layer 1 RSRP or CQI measurement) based on the indicated source reference signal, the indicated monitoring occasions, the indicated search spaces, the indicated control resource sets, or any combination thereof. For example, the UE 115-b may receive the DMRS 330 on an indicated search space, monitoring occasion, or control resource set, and the UE 115-b may determine the differential measurement based on the DMRS for the indicated source reference signal.

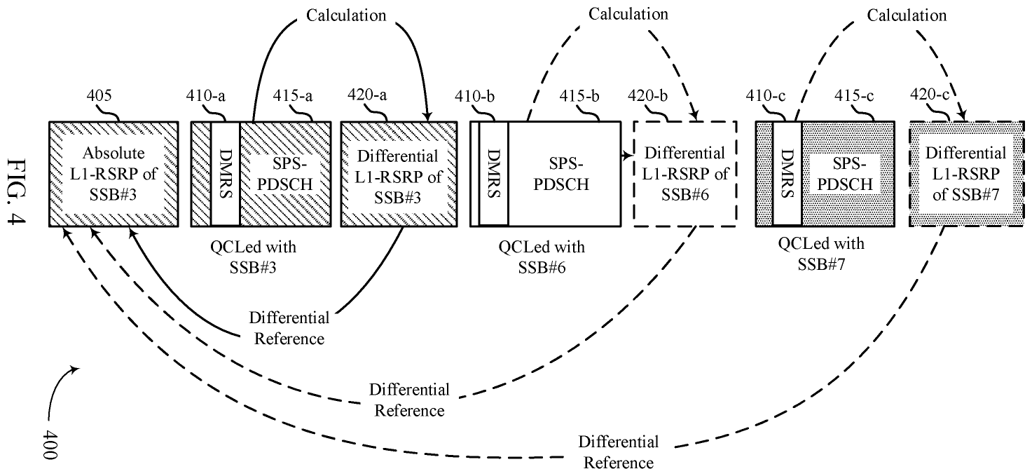

FIG. 4 illustrates an example of a differential beam quality reporting scheme 400 that supports explicit and implicit precoder indication for DMRS-based CSI reporting in accordance with one or more aspects of the present disclosure. In some examples, differential beam quality reporting scheme 400 may implement aspects of wireless communications system 300. Differential beam quality reporting scheme 400 may enable a UE 115 to identify DMRS for deriving differential beam qualities based on source reference signals. In some cases, the DMRS may be identified based on an indication of a source reference signal from a network entity.

In some cases, the DMRS for determining the differential measurement may be received on PDSCH. The DMRS may be associated with multiple source reference signals, and in some cases, different resource reference signals may be transmitted by different network entities 105 or different TRPs, such as in an mTRP configuration. For example, the UE may receive DMRSs, such as DMRS 410-a, DMRS 410-b, and DMRS 410-c, that are transmitted by multiple TRPs. The DMRS 410 may be transmitted on PDSCH resources that are quasi co-located with different source reference signals, such as different SSBs. For example, DMRS 410-a may be transmitted on PDSCH 415-a, which is quasi co-located with SSB #3. DMRS 410-b may be transmitted on PDSCH 415-b, which is quasi co-located with SSB #6, and DMRS 410-c may be transmitted on PDSCH 415-c, which may be quasi co-located with SSB #7.

A network entity 105 may transmit control signaling to configure the UE 115 to report a differential measurement associated with a source reference signal. For example, the network entity 105 may configure the UE 115 to report a differential measurement associated with SSB #3. In some cases, the UE 115 may be configured to report the differential measurement with respect to a previous (e.g., latest or most recent) measurement for SSB #3, such as an absolute measurement 405, which may be an absolute L1 RSRP measurement of SSB #3 or a CQI measurement of SSB #3.

The control signaling may indicate the source reference signal from the multiple source reference signals that are quasi co-located with the DMRSs 410. For example, the network entity 105 may indicate a source reference signal for DMRS 410-a transmitted on PDSCH 415-a by indicating a TCI state or a reference signal identifier (e.g., SSBRI or CRI) of the source reference signal. The UE 115 may measure the DMRS 410-a on the PDSCH 415-a which is quasi co-located with the indicated source reference signal to calculate the differential measurement for the source reference signal. For example, the UE may determine a differential L1-RSRP of SSB #3, and the UE 115 may report the differential measurement 420-a to the network entity 105.

In some cases, the differential measurement 420-a may be determined with reference to the absolute measurement 405. For example, the differential measurement 420-a may be correspond to a differential or a difference between the absolute measurement 405 and a measurement taken based on the DMRS 410-a.

In some examples, the DMRS 410 may be transmitted on PDSCH 415 via an mTRP scheme, where different TRPs of the mTRP scheme transmit the PDSCH 415. For example, the network entity 105 may include multiple TRPs, including a first TRP which transmits to the UE 115 on the PDSCH 415 in a direction corresponding to SSB #3. A second TRP of the network entity 105 may also transmit to the UE 115 on the PDSCH 415 in a direction corresponding to SSB #6. In another example, the PDSCH 415 may be examples of SPS PDSCH, where network entities 105, or TRPs of a network entity 105, apply a time domain precoder cycling to transmit on the PDSCH 415. For example, the first TRP may transmit on a first SPS PDSCH (e.g., PDSCH 415-a) on a beam direction corresponding to SSB #3, and a second TRP may transmit on a second SPS PDSCH (e.g., PDSCH 415-b) on a beam direction corresponding to SSB #6. That is, a network entity, via multiple TRPs, or multiple network entities may use precoder cycling for SPS PDSCH, where respective PDSCH resources may be quasi co-located with different source reference signals in different PDSCH occasions.

To indicate a source reference signal for a differential measurement, the network entity may indicate TCI state associated with the source reference signal or a reference signal identifier, or both. For example, the network entity 105 may indicate a TCI state including a single Type D QCL source reference signal, which may explicitly indicate a source reference signal for a differential measurement. In another example, the network entity 105 may indicate, for example, an SSBRI or a CRI associated with the source reference signal. When calculating the differential measurement 420-a, the UE 115 may only consider or measure PDSCH DMRS that are associated with the indicated TCI state or quasi co-located with the indicated reference signal.

In some implementations, the UE 115 may report a differential measurement associated with a source reference signal based on any or all associated PDSCH or PDCCH DMRS. For example, the UE 115 may receive the DMRS 410-a on the SPS PDSCH 415-a that is quasi co-located with SSB #3 and receive the DMRS 410-b on the SPS PDSCH 415-b that is quasi co-located with the SSB #6. The UE 115 may transmit a first differential measurement 420-a with respect to the absolute measurement 405 based on the DMRS 410-a and a second differential measurement 420-b with respect to the absolute measurement 405 based on the DMRS 410-b. Similarly, the UE 115 may transmit a third differential measurement 420-c with respect to the absolute measurement 405 based on a DMRS 410-c received on a PDSCH 415-c that is quasi co-located with another source reference signal, such as an SSB #7.

In this example, even if the a DMRS is received on a PDSCH 415 that is quasi co-located with multiple source reference signals or a different source reference signal than the absolute measurement 405, the UE 115 still report a differential measurement with respect to the absolute measurement 405. The UE 115 may be configured with a periodic or semi-persistent CSI reporting resource, which may have a same periodicity as the SPS PDSCH. The UE 115-may report the differential quantities calculated based on the received PDSCH DMRS, despite the type-D QCL source reference associated with a specific PDSCH occasion. The network entity 105 may determine how to use the reported differential measurements 420 (e.g., the reported layer one (L1)-RSRPs associated with the PDSCHs not QCL'd with the target source reference signal can still be used). For example, the network entity 105 may still determine channel characteristics or make beam management determinations based on differential measurements 420 for PDSCH resources that are not quasi co-located with the source reference signal.

In some implementations, the UE 115 may not expect to report a differential measurement associated with a source reference signal. For example, if the source reference signal is one of multiple source reference signals associated with a PDSCH or PDCCH received by the UE 115 (e.g., one of multiple Type D quasi co-located source reference signals associated with the PDSCH or PDCCH), the UE 115 may not expect to transmit a differential measurement (e.g., a differential L1 RSRP or CQI measurement) for the source reference signal and the differential reporting is referred to a recently reported L1-RSRP/CQI associated with the first source reference signal.

In some implementations, a network entity 105 may enable or disable differential measurement reporting. For example, a network entity 105 may toggle differential measurement reporting for one or more source reference signals. The network entity 105 may enable or disable measurement reporting, or both, via control signaling, such as downlink control information, a MAC CE, or RRC signaling.

The UE 115 may report a differential measurement 420, such as the differential measurement 420-b, to the network entity 105. The network entity 105 may then then use differential measurement 420 for beam management. In some examples, the network entity 105 may determine an updated absolute RSRP or updated CQI for a beam corresponding to the source reference signal based on the differential measurement 420 for the source reference signal.

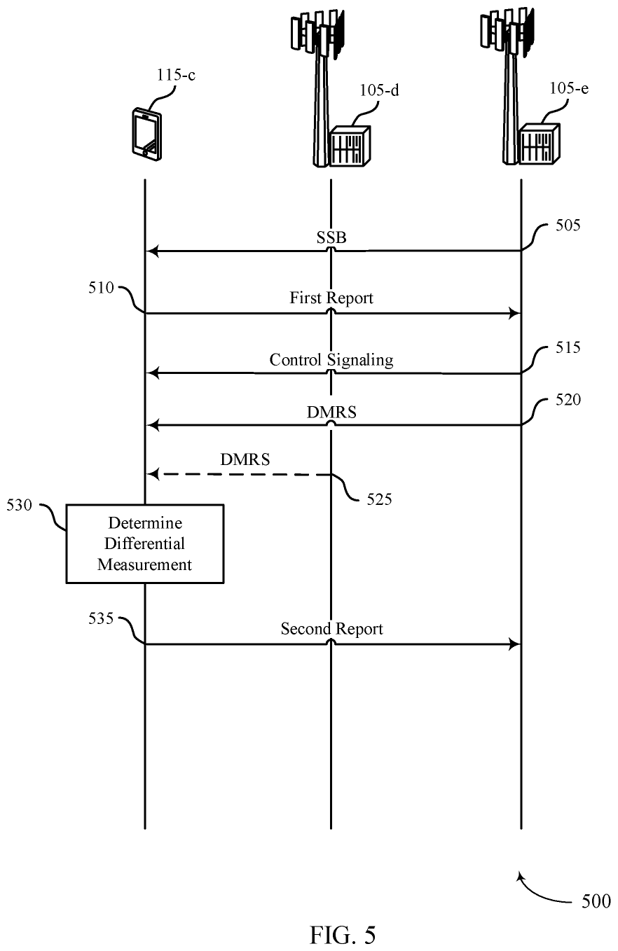

FIG. 5 illustrates an example of a process flow 500 that supports explicit and implicit precoder indication for DMRS-based CSI reporting in accordance with one or more aspects of the present disclosure. In some examples, the process flow 500 may implement aspects of wireless communications system 100.

The process flow 500 may include one or more network entities 105, such as a network entity 105-d and a network entity 105-e, which may be examples of a network entity 105 as described herein. In some examples, the network entity 105-d and the network entity 105-e may be examples of separate TRPs of a single network entity 105, such as in an mTRP configuration. The process flow may also include a UE 115-c, which may be an example of a UE 115 described herein. The process flow 500 may illustrate an example of techniques which enable a UE 115 to identify DMRS for deriving differential beam qualities based on a source reference signals. For example, the UE 115 may be configured to report a differential measurement for a source reference signal based on DMRS, where the DMRS may be transmitted on downlink channels (e.g., PDSCH or PDCCH) that are quasi co-located with multiple source reference signals.

At 505, the network entity 105-e may transmit an SSB to the UE 115-c. The SSB may be associated with, or may be an example of, a source reference signal. Some wireless communications systems may implement a hierarchical beam refinement procedure for a UE 115-c and a network entity 105-e to communicate. In this case, the UE 115-c may perform SSB beam sweeping to select a wide beam pair for communication by periodically transmitting SSBs in different beam directions. The UE 115-c may perform beam management with an increased periodicity using the wide beam pair. In some cases, the UE 115-c may predict a strongest beam at a future time to support the lower rate and increased periodicity of high-level beam management. The UE 115-c may rank beams based on the strongest beam predictions and select the strongest beam pair to use based on the ranking.

At 510, the UE 115-c may transmit a first report indicating a measurement for a first beam based on the source reference signal associated with the SSB. For example, the UE 115-c may transmit an absolute RSRP measurement or an absolute CQI measurement to the network entity 105-e for a source reference signal. In an example, the UE 115-c may transmit an absolute L1 RSRP measurement of an SSB.

At 515, the UE 115-c may receive control signaling configuring the UE 115-c to report a differential measurement for a source reference signal. The control signaling may indicate, or include an indication of, the source reference signal from a set of multiple source reference signals that are quasi co-located with DMRSs. the control signaling may be transmitted via downlink control information, a MAC CE, RRC signaling, or any combination thereof.

The UE 115-c may be configured to determine the differential measurement by measuring DMRS transmitted on PDSCH or PDCCH resources that are quasi co-located with at least the source reference signal. For example, the UE 115-c may be configured or scheduled for PDSCH resources that are configured or scheduled according to an mTRP configuration or SPS PDSCH with a time domain precoder cycling. In this example, the control signaling may indicate a TCI state including a single Type D quasi co-located source reference signal, a reference signal identifier, or both.

In some examples, the UE 115-c may be configured or scheduled for PDCCH resources that are configured with a frequency domain precoder cycling. In this example, the control signaling may indicate a TCI state including a single Type D quasi co-located source reference signal, a reference signal identifier, identifiers for a group of REGs, or any combination thereof. For example, the UE 115-c may calculate the differential measurement based on the source reference signal or PDCCH DMRS included in the indicated group of REGs.

In some examples, the UE 115-c may be configured or scheduled for PDCCH resources that are configured with a time domain precoder cycling with PDCCH repetitions. In this example, the control signaling may indicate a TCI state including a single Type D quasi co-located source reference signal, a reference signal identifier (e.g., SSBRI, CRI), a number of PDCCH monitoring occasion identifier associated with a set of PDCCH repetitions, a number of PDCCH search space identifier associated with a set of PDCCH repetitions, a number of control resource set identifier associated with a set of PDCCH repetitions, or any combination thereof. For example, the UE 115-c may calculate the differential measurement based on the indicated source reference signal, or the indicated PDCCH monitoring occasions, search spaces, or control resource sets, or any combination thereof.

At 520, the network entity 105-e may transmit DMRS on a downlink channel (e.g., PDCCH or PDSCH) quasi co-located with the source reference signal. In some cases, at 525, the network entity 105-d may also transmit DMRS on other downlink channels which are quasi co-located with another source reference signal. Therefore, DMRS for downlink channels may be associated with multiple (e.g., at least two different) source reference signals. However, based on the indication in the control signaling received at 515, the UE 115-c may identify DMRS which are received on the downlink channel quasi co-located with the source reference signal from the network entity 105-e to perform the differential measurement.

At 530, the UE 115-c may determine the differential measurement for the source reference signal based on measuring a DMRS that is quasi co-located with the source reference signal. For example, the UE 115-c may calculate a differential L1-RSRP, differential CQI, or both associated with the indicated source reference signal. For example, the UE 115-c may determine the differential beam quality with reference to a recently reported RSRP measurement, CQI, or both, associated with the source reference signal.

At 535, the UE 115-c may transmit, to the network entity 105-e, a second report indicating the differential measurement of the source reference signal. In some examples, the network entity 105-e may perform beam management based on the second report and the differential measurement of the source reference signal. For example, the network entity 105-e may perform beam management between the longer periodicities of a full L1 beam report.

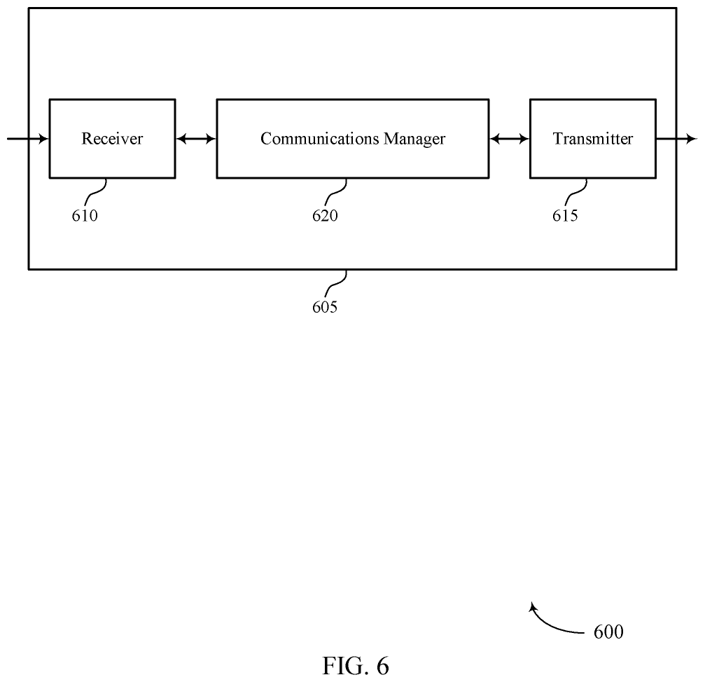

FIG. 6 shows a block diagram 600 of a device 605 that supports explicit and implicit precoder indication for DMRS-based CSI reporting in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to explicit and implicit precoder indication for DMRS-based CSI reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to explicit and implicit precoder indication for DMRS-based CSI reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of explicit and implicit precoder indication for DMRS-based CSI reporting as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for transmitting, to a first network entity, a first report indicating a measurement for a first beam based on a source reference signal. The communications manager 620 may be configured as or otherwise support a means for receiving control signaling configuring the UE to report a differential measurement for the source reference signal, where the control signaling includes an indication of the source reference signal from a set of multiple source reference signals that are quasi co-located with a set of multiple DMRSs. The communications manager 620 may be configured as or otherwise support a means for determining the differential measurement for the source reference signal based on measuring a DMRS that is quasi co-located with the source reference signal, where the differential measurement is with reference to a most recently reported beam measurement for the source reference signal. The communications manager 620 may be configured as or otherwise support a means for transmitting, to the first network entity, a second report indicating the differential measurement for the source reference signal.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption.

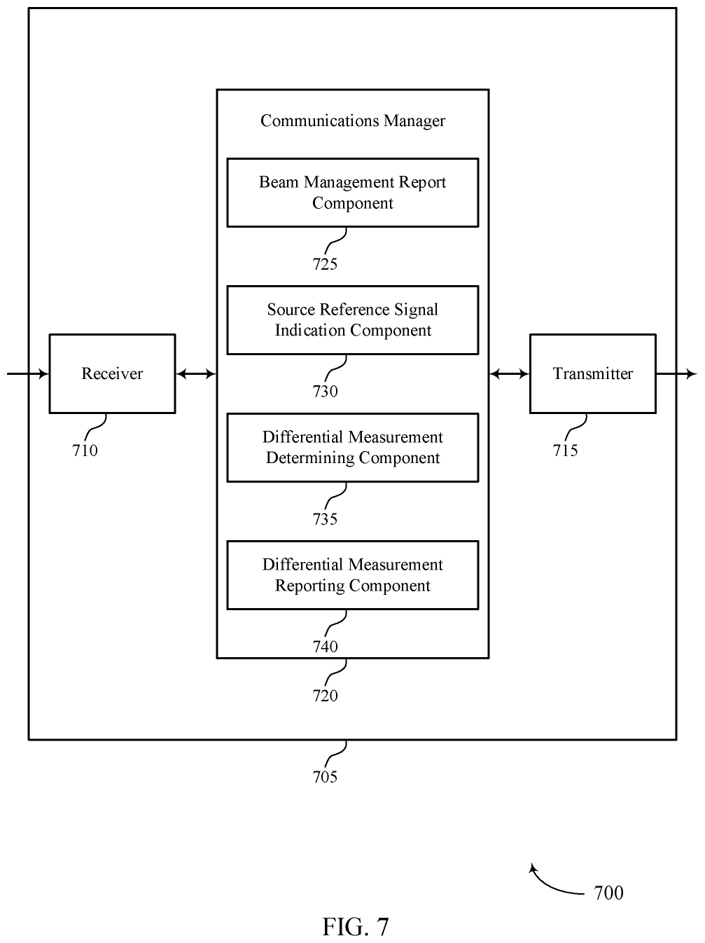

FIG. 7 shows a block diagram 700 of a device 705 that supports explicit and implicit precoder indication for DMRS-based CSI reporting in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to explicit and implicit precoder indication for DMRS-based CSI reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to explicit and implicit precoder indication for DMRS-based CSI reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of explicit and implicit precoder indication for DMRS-based CSI reporting as described herein. For example, the communications manager 720 may include a beam management report component 725, a source reference signal indication component 730, a differential measurement determining component 735, a differential measurement reporting component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The beam management report component 725 may be configured as or otherwise support a means for transmitting, to a first network entity, a first report indicating a measurement for a first beam based on a source reference signal. The source reference signal indication component 730 may be configured as or otherwise support a means for receiving control signaling configuring the UE to report a differential measurement for the source reference signal, where the control signaling includes an indication of the source reference signal from a set of multiple source reference signals that are quasi co-located with a set of multiple DMRSs. The differential measurement determining component 735 may be configured as or otherwise support a means for determining the differential measurement for the source reference signal based on measuring a DMRS that is quasi co-located with the source reference signal, where the differential measurement is with reference to a most recently reported beam measurement for the source reference signal. The differential measurement reporting component 740 may be configured as or otherwise support a means for transmitting, to the first network entity, a second report indicating the differential measurement for the source reference signal.

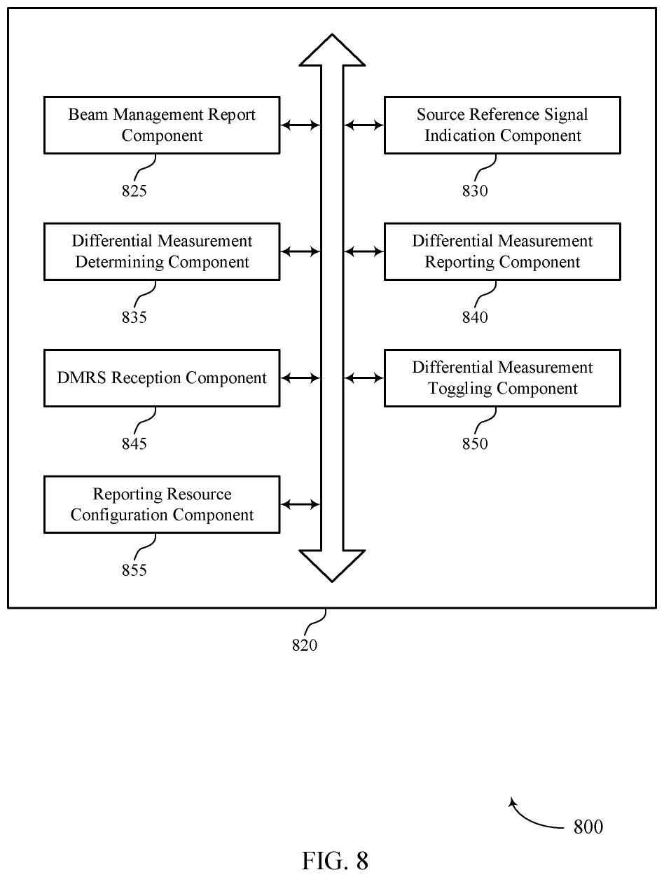

FIG. 8 shows a block diagram 800 of a communications manager 820 that supports explicit and implicit precoder indication for DMRS-based CSI reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of explicit and implicit precoder indication for DMRS-based CSI reporting as described herein. For example, the communications manager 820 may include a beam management report component 825, a source reference signal indication component 830, a differential measurement determining component 835, a differential measurement reporting component 840, a DMRS reception component 845, a differential measurement toggling component 850, a reporting resource configuration component 855, or any combination thereof. Each of these components may communicate, directly or indirectly, with one another (e.g., via one or more buses).

The communications manager 820 may support wireless communications at a UE in accordance with examples as disclosed herein. The beam management report component 825 may be configured as or otherwise support a means for transmitting, to a first network entity, a first report indicating a measurement for a first beam based on a source reference signal. The source reference signal indication component 830 may be configured as or otherwise support a means for receiving control signaling configuring the UE to report a differential measurement for the source reference signal, where the control signaling includes an indication of the source reference signal from a set of multiple source reference signals that are quasi co-located with a set of multiple DMRSs. The differential measurement determining component 835 may be configured as or otherwise support a means for determining the differential measurement for the source reference signal based on measuring a DMRS that is quasi co-located with the source reference signal, where the differential measurement is with reference to a most recently reported beam measurement for the source reference signal. The differential measurement reporting component 840 may be configured as or otherwise support a means for transmitting, to the first network entity, a second report indicating the differential measurement for the source reference signal.

In some examples, the DMRS reception component 845 may be configured as or otherwise support a means for receiving the DMRS on a downlink shared channel that is quasi co-located with the source reference signal.

In some examples, to support determining the differential measurement, the differential measurement determining component 835 may be configured as or otherwise support a means for determining the differential measurement from the DMRS based on the DMRS being associated with a transmission configuration indicator state of the source reference signal.

In some examples, the indication of the source reference signal includes a transmission configuration indicator state associated with the source reference signal, a reference signal identifier for the source reference signal, or both.

In some examples, the reference signal identifier is a synchronization signal block resource identifier or a CSI reference signal resource identifier.

In some examples, the downlink shared channel is a semi-persistent scheduling downlink shared channel.

In some examples, the DMRS reception component 845 may be configured as or otherwise support a means for receiving the DMRS on a downlink control channel with a frequency domain precoder cycling, where the downlink control channel is quasi co-located with the source reference signal.

In some examples, to support receiving the DMRS, the differential measurement determining component 835 may be configured as or otherwise support a means for receiving the DMRS in one or more resource element groups associated with the source reference signal based on the indication of the source reference signal.

In some examples, the indication of the source reference signal includes a transmission configuration indicator state associated with the source reference signal, a reference signal identifier for the source reference signal, a group of resource element groups, or any combination thereof.

In some examples, the differential measurement determining component 835 may be configured as or otherwise support a means for receiving the DMRS on a downlink control channel with a time domain precoder cycling, where the downlink control channel is quasi co-located with the source reference signal.

In some examples, to support receiving the DMRS, the DMRS reception component 845 may be configured as or otherwise support a means for receiving the DMRS in a monitoring occasion associated with the source reference signal, a search space associated with the source reference signal, a control resource set associated with the source reference signal, or any combination thereof, based on the indication of the source reference signal.

In some examples, the indication of the source reference signal includes a transmission configuration indicator state associated with the source reference signal, a reference signal identifier for the source reference signal, one or more downlink control channel monitoring occasion identifiers associated with a set of downlink control channel repetitions, one or more downlink control channel search space identifier associated with a set of downlink control channel repetitions, or any combination thereof.

In some examples, the differential measurement determining component 835 may be configured as or otherwise support a means for determining a second differential measurement for the source reference signal based on measuring a second DMRS of the set of multiple DMRSs. In some examples, the differential measurement reporting component 840 may be configured as or otherwise support a means for transmitting, to network entity, a third report indicating the second differential measurement for the source reference signal. In some examples, the differential measurement may be with reference to a most recently reported beam measurement for the source reference signal or a latest beam measurement.

In some examples, the reporting resource configuration component 855 may be configured as or otherwise support a means for receiving a control message configuring resources for a CSI report corresponding, the resources corresponding to a periodicity of a semi-periodic scheduling downlink shared channel resource carrying the set of multiple DMRSs, where the second report is a first CSI report, and the third report is a second CSI report.

In some examples, to support transmitting the second report, the differential measurement reporting component 840 may be configured as or otherwise support a means for transmitting a CSI report indicating the differential measurement.

In some examples, the differential measurement toggling component 850 may be configured as or otherwise support a means for receiving, from network entity, a control message disabling reporting differential measurements for the source reference signal.

In some examples, the control message is received via a medium access control element or downlink control information, or both.

In some examples, the set of multiple source reference signals are transmitted by a set of multiple transmission reception points, the first network entity corresponding to a first transmission reception point of the set of multiple transmission reception points.

In some examples, the differential measurement is a differential reference signal received power measurement, a differential channel quality indicator measurement, or both, with reference to the measurement for the first beam.

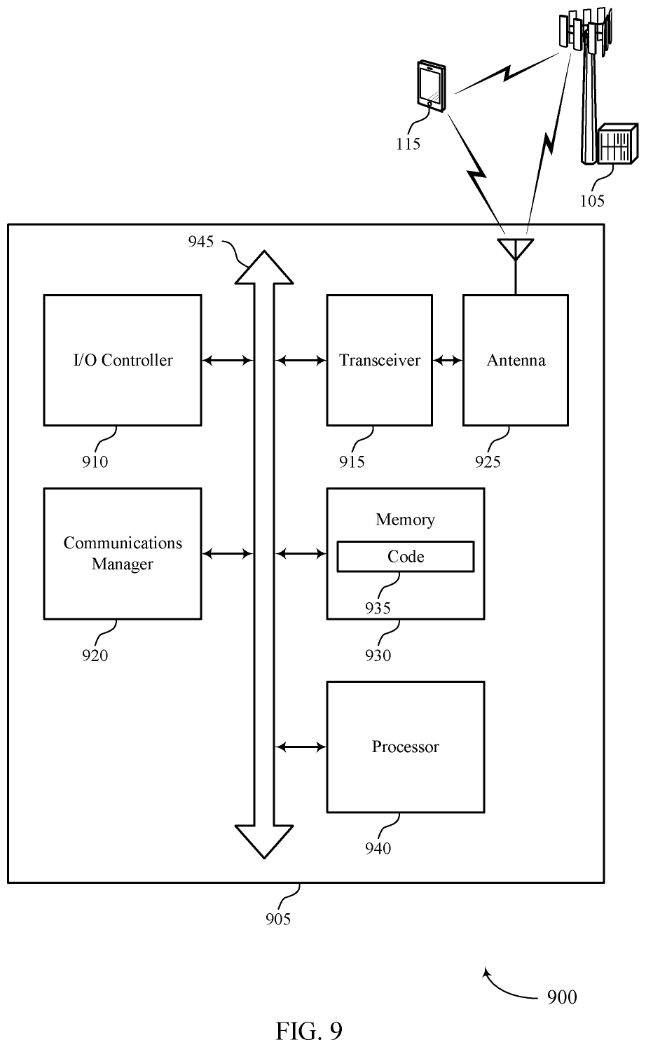

FIG. 9 shows a diagram of a system 900 including a device 905 that supports explicit and implicit precoder indication for DMRS-based CSI reporting in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting explicit and implicit precoder indication for DMRS-based CSI reporting). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for transmitting, to a first network entity, a first report indicating a measurement for a first beam based on a source reference signal. The communications manager 920 may be configured as or otherwise support a means for receiving control signaling configuring the UE to report a differential measurement for the source reference signal, where the control signaling includes an indication of the source reference signal from a set of multiple source reference signals that are quasi co-located with a set of multiple DMRSs. The communications manager 920 may be configured as or otherwise support a means for determining the differential measurement for the source reference signal based on measuring a DMRS that is quasi co-located with the source reference signal, where the differential measurement is with reference to a most recently reported beam measurement for the source reference signal. The communications manager 920 may be configured as or otherwise support a means for transmitting, to the first network entity, a second report indicating the differential measurement for the source reference signal.

By including or configuring the communications manager 920 in accordance with examples as described herein, the device 905 may support techniques for reduced power consumption.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of explicit and implicit precoder indication for DMRS-based CSI reporting as described herein, or the processor 940 and the memory 930 may be otherwise configured to perform or support such operations.

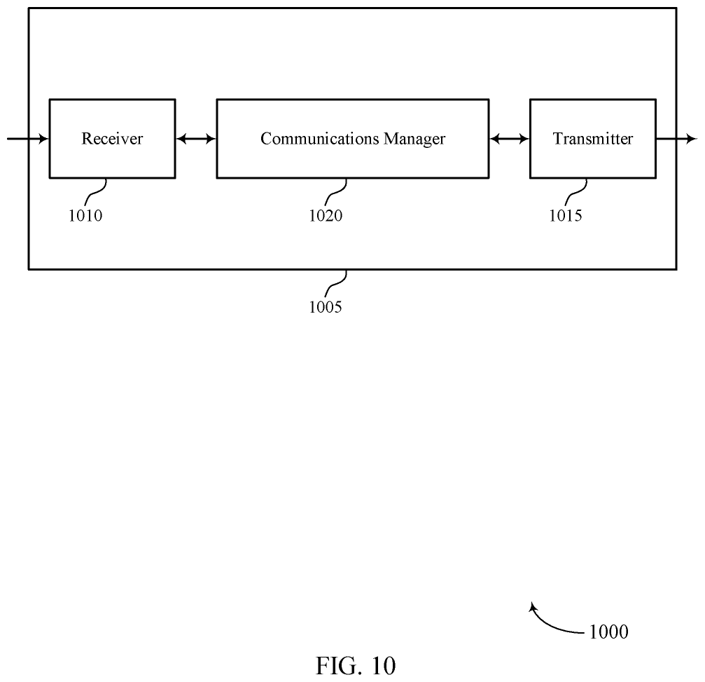

FIG. 10 shows a block diagram 1000 of a device 1005 that supports explicit and implicit precoder indication for DMRS-based CSI reporting in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of explicit and implicit precoder indication for DMRS-based CSI reporting as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for receiving a first report indicating a measurement for a first beam based on a source reference signal. The communications manager 1020 may be configured as or otherwise support a means for transmitting control signaling configuring a UE to report a differential measurement for the source reference signal, where the control signaling includes an indication of the source reference signal from a set of multiple source reference signals that are quasi co-located with a set of multiple DMRSs and the differential measurement is with reference to a most recently reported beam measurement for the source reference signal. The communications manager 1020 may be configured as or otherwise support a means for receiving a second report indicating the differential measurement for the source reference signal based on a DMRS that is quasi co-located with the source reference signal, where the differential measurement is with reference to a most recently reported beam measurement for the source reference signal.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption.

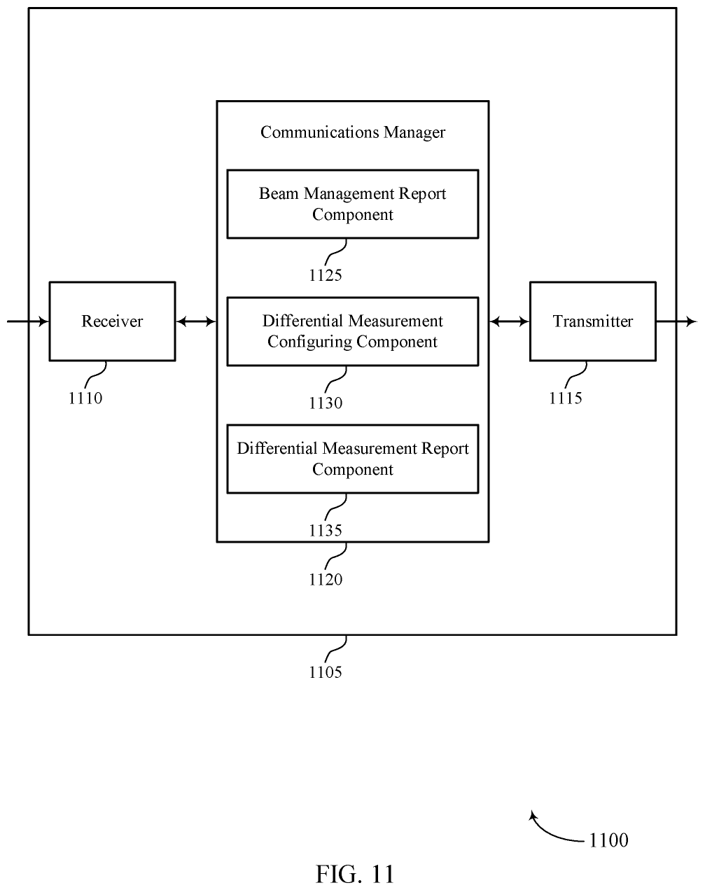

FIG. 11 shows a block diagram 1100 of a device 1105 that supports explicit and implicit precoder indication for DMRS-based CSI reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of explicit and implicit precoder indication for DMRS-based CSI reporting as described herein. For example, the communications manager 1120 may include a beam management report component 1125, a differential measurement configuring component 1130, a differential measurement report component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The beam management report component 1125 may be configured as or otherwise support a means for receiving a first report indicating a measurement for a first beam based on a source reference signal. The differential measurement configuring component 1130 may be configured as or otherwise support a means for transmitting control signaling configuring a UE to report a differential measurement for the source reference signal, where the control signaling includes an indication of the source reference signal from a set of multiple source reference signals that are quasi co-located with a set of multiple DMRSs. The differential measurement report component 1135 may be configured as or otherwise support a means for receiving a second report indicating the differential measurement for the source reference signal based on a DMRS that is quasi co-located with the source reference signal, where the differential measurement is determined with reference to a most recently reported beam measurement for the source reference signal.

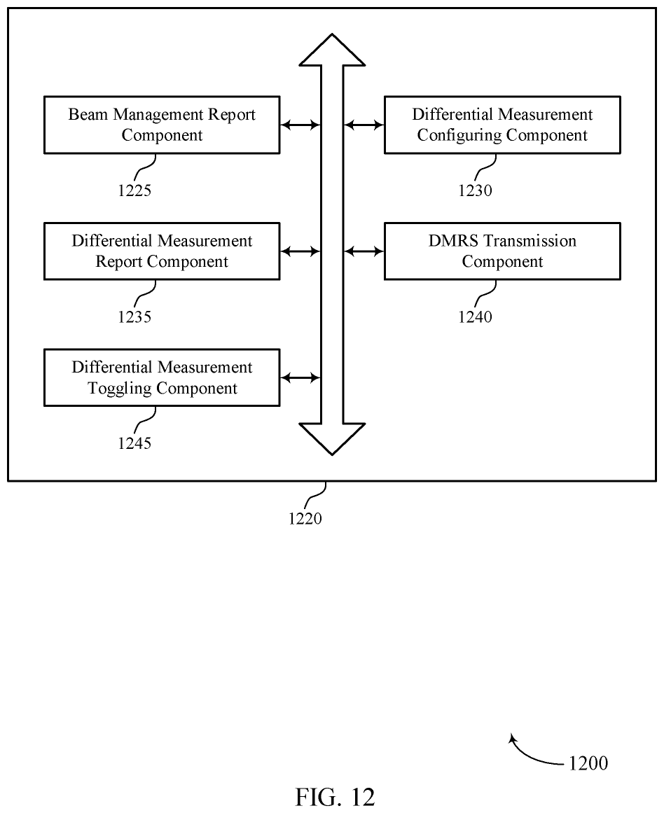

FIG. 12 shows a block diagram 1200 of a communications manager 1220 that supports explicit and implicit precoder indication for DMRS-based CSI reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of explicit and implicit precoder indication for DMRS-based CSI reporting as described herein. For example, the communications manager 1220 may include a beam management report component 1225, a differential measurement configuring component 1230, a differential measurement report component 1235, a DMRS transmission component 1240, a differential measurement toggling component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The beam management report component 1225 may be configured as or otherwise support a means for receiving a first report indicating a measurement for a first beam based on a source reference signal. The differential measurement configuring component 1230 may be configured as or otherwise support a means for transmitting control signaling configuring a UE to report a differential measurement for the source reference signal, where the control signaling includes an indication of the source reference signal from a set of multiple source reference signals that are quasi co-located with a set of multiple DMRSs. The differential measurement report component 1235 may be configured as or otherwise support a means for receiving a second report indicating the differential measurement for the source reference signal based on a DMRS that is quasi co-located with the source reference signal, where the differential measurement is determined with reference to a most recently reported beam measurement for the source reference signal.

In some examples, the DMRS transmission component 1240 may be configured as or otherwise support a means for transmitting the DMRS on a downlink shared channel that is quasi co-located with the source reference signal.

In some examples, the DMRS transmission component 1240 may be configured as or otherwise support a means for transmitting the DMRS on a downlink control channel with a frequency domain precoder cycling, where the downlink control channel is quasi co-located with the source reference signal.

In some examples, to support transmitting the DMRS, the DMRS transmission component 1240 may be configured as or otherwise support a means for transmitting the DMRS in one or more resource element groups associated with the source reference signal based on the indication of the source reference signal.

In some examples, the DMRS transmission component 1240 may be configured as or otherwise support a means for transmitting the DMRS on a downlink control channel with a time domain precoder cycling, where the downlink control channel is quasi co-located with the source reference signal.

In some examples, the differential measurement report component 1235 may be configured as or otherwise support a means for receiving a third report indicating a second differential measurement for the source reference signal based on a second DMRS quasi co-located with a second source reference signal of the set of multiple source reference signals.

In some examples, the differential measurement toggling component 1245 may be configured as or otherwise support a means for transmitting a control message disabling reporting differential measurements for the source reference signal.

In some examples, the network entity corresponds to a first transmission reception point of a set of multiple transmission reception points.

In some examples, the differential measurement is a differential reference signal received power measurement, a differential channel quality indicator measurement, or both, with reference to the measurement for the first beam.

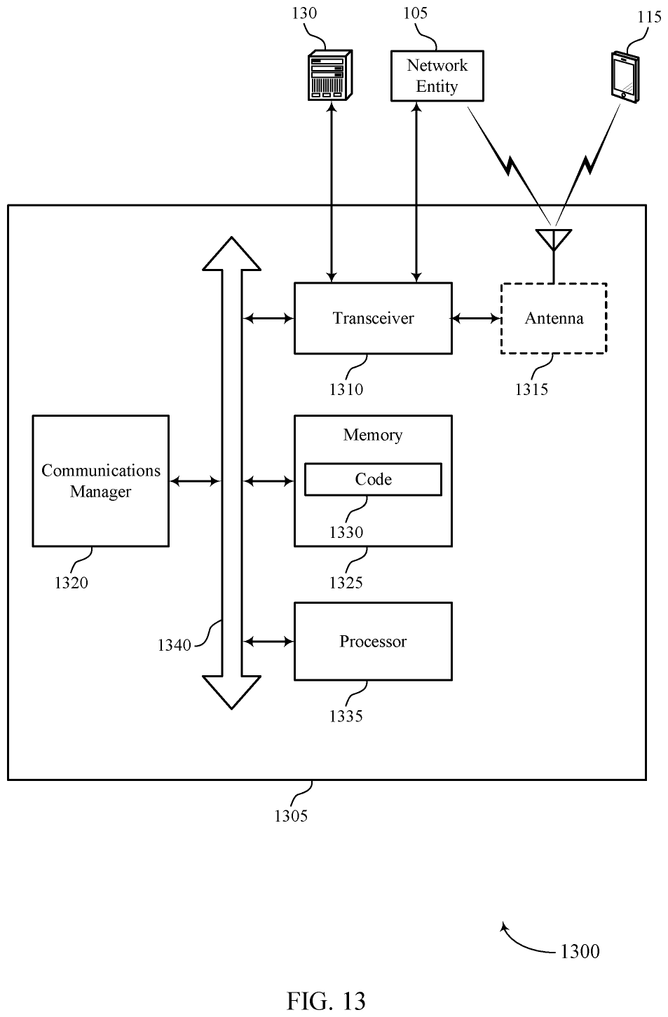

FIG. 13 shows a diagram of a system 1300 including a device 1305 that supports explicit and implicit precoder indication for DMRS-based CSI reporting in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting explicit and implicit precoder indication for DMRS-based CSI reporting). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for receiving a first report indicating a measurement for a first beam based on a source reference signal. The communications manager 1320 may be configured as or otherwise support a means for transmitting control signaling configuring a UE to report a differential measurement for the source reference signal, where the control signaling includes an indication of the source reference signal from a set of multiple source reference signals that are quasi co-located with a set of multiple DMRSs. The communications manager 1320 may be configured as or otherwise support a means for receiving a second report indicating the differential measurement for the source reference signal based on a DMRS that is quasi co-located with the source reference signal, where the differential measurement is determined with reference to a most recently reported beam measurement for the source reference signal.

By including or configuring the communications manager 1320 in accordance with examples as described herein, the device 1305 may support techniques for reduced power consumption.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of explicit and implicit precoder indication for DMRS-based CSI reporting as described herein, or the processor 1335 and the memory 1325 may be otherwise configured to perform or support such operations.

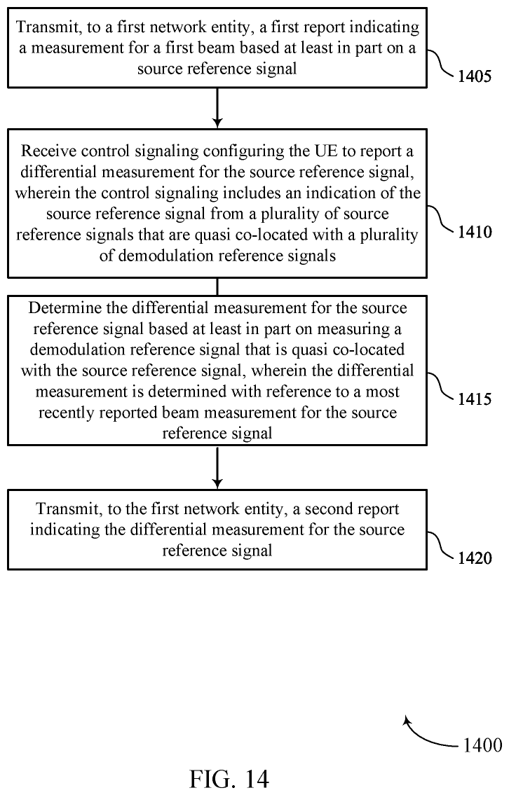

FIG. 14 shows a flowchart illustrating a method 1400 that supports explicit and implicit precoder indication for DMRS-based CSI reporting in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, to a first network entity, a first report indicating a measurement for a first beam based on a source reference signal. The operations of 1405 may be performed in accordance with examples as disclosed herein. In some examples, aspects of the operations of 1405 may be performed by a beam management report component 825 as described with reference to FIG. 8.

At 1410, the method may include receiving control signaling configuring the UE to report a differential measurement for the source reference signal, where the control signaling includes an indication of the source reference signal from a set of multiple source reference signals that are quasi co-located with a set of multiple DMRSs. The operations of 1410 may be performed in accordance with examples as disclosed herein. In some examples, aspects of the operations of 1410 may be performed by a source reference signal indication component 830 as described with reference to FIG. 8.

At 1415, the method may include determining the differential measurement for the source reference signal based on measuring a DMRS that is quasi co-located with the source reference signal, where the differential measurement is determined with reference to a most recently reported beam measurement for the source reference signal. The operations of 1415 may be performed in accordance with examples as disclosed herein. In some examples, aspects of the operations of 1415 may be performed by a differential measurement determining component 835 as described with reference to FIG. 8.

At 1420, the method may include transmitting, to the first network entity, a second report indicating the differential measurement for the source reference signal. The operations of 1420 may be performed in accordance with examples as disclosed herein. In some examples, aspects of the operations of 1420 may be performed by a differential measurement reporting component 840 as described with reference to FIG. 8.

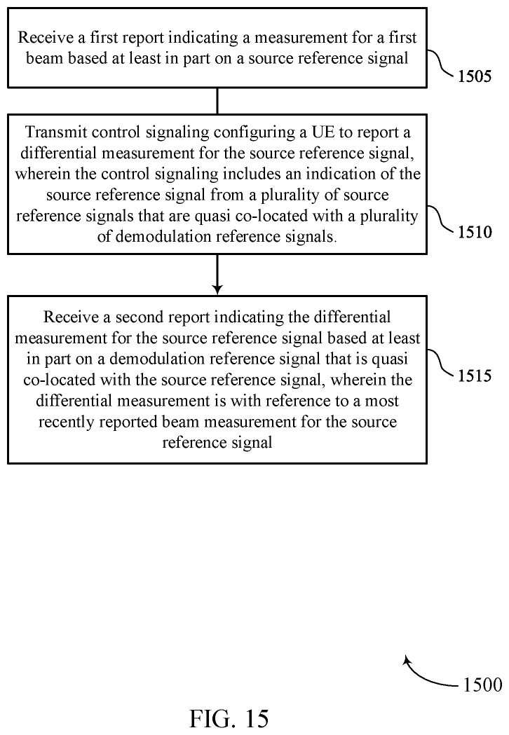

FIG. 15 shows a flowchart illustrating a method 1500 that supports explicit and implicit precoder indication for DMRS-based CSI reporting in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include receiving a first report indicating a measurement for a first beam based on a source reference signal. The operations of 1505 may be performed in accordance with examples as disclosed herein. In some examples, aspects of the operations of 1505 may be performed by a beam management report component 1225 as described with reference to FIG. 12.

At 1510, the method may include transmitting control signaling configuring a UE to report a differential measurement for the source reference signal, where the control signaling includes an indication of the source reference signal from a set of multiple source reference signals that are quasi co-located with a set of multiple DMRSs. The operations of 1510 may be performed in accordance with examples as disclosed herein. In some examples, aspects of the operations of 1510 may be performed by a differential measurement configuring component 1230 as described with reference to FIG. 12.

At 1515, the method may include receiving a second report indicating the differential measurement for the source reference signal based on a DMRS that is quasi co-located with the source reference signal, where the differential measurement is determined with reference to a most recently reported beam measurement for the source reference signal. In some examples, aspects of the operations of 1515 may be performed by a differential measurement report component 1235 as described with reference to FIG. 12.

The following provides an overview of aspects of the present disclosure:

Aspect 1: A method for wireless communications at a UE, comprising: transmitting, to a first network entity, a first report indicating a measurement for a first beam based at least in part on a source reference signal; receiving control signaling configuring the UE to report a differential measurement for the source reference signal, wherein the control signaling includes an indication of the source reference signal from a plurality of source reference signals that are quasi co-located with a plurality of demodulation reference signals; determining the differential measurement for the source reference signal based at least in part on measuring a demodulation reference signal that is quasi co-located with the source reference signal, wherein the differential measurement is determined with reference to a most recently reported beam measurement for the source reference signal; and transmitting, to the first network entity, a second report indicating the differential measurement for the source reference signal.

Aspect 2: The method of aspect 1, further comprising: receiving the demodulation reference signal on a downlink shared channel that is quasi co-located with the source reference signal.

Aspect 3: The method of aspect 2, wherein determining the differential measurement comprises: determining the differential measurement from the demodulation reference signal based at least in part on the demodulation reference signal being associated with a transmission configuration indicator state of the source reference signal.

Aspect 4: The method of any of aspects 2 through 3, wherein the indication of the source reference signal includes a transmission configuration indicator state associated with the source reference signal, a reference signal identifier for the source reference signal, or both.

Aspect 5: The method of aspect 4, wherein the reference signal identifier is a synchronization signal block resource identifier or a channel state information reference signal resource identifier.

Aspect 6: The method of any of aspects 2 through 5, wherein the downlink shared channel is a semi-persistent scheduling downlink shared channel.

Aspect 7: The method of any of aspects 1 through 6, further comprising: receiving the demodulation reference signal on a downlink control channel with a frequency domain precoder cycling, wherein the downlink control channel is quasi co-located with the source reference signal.

Aspect 8: The method of aspect 7, wherein receiving the demodulation reference signal comprises: receiving the demodulation reference signal in one or more resource element groups associated with the source reference signal based at least in part on the indication of the source reference signal.

Aspect 9: The method of any of aspects 7 through 8, wherein the indication of the source reference signal includes a transmission configuration indicator state associated with the source reference signal, a reference signal identifier for the source reference signal, a group of resource element groups, or any combination thereof.

Aspect 10: The method of any of aspects 1 through 9, further comprising: receiving the demodulation reference signal on a downlink control channel with a time domain precoder cycling, wherein the downlink control channel is quasi co-located with the source reference signal.

Aspect 11: The method of aspect 10, wherein receiving the demodulation reference signal comprises: receiving the demodulation reference signal in a monitoring occasion associated with the source reference signal, a search space associated with the source reference signal, a control resource set associated with the source reference signal, or any combination thereof, based at least in part on the indication of the source reference signal.

Aspect 12: The method of any of aspects 10 through 11, wherein the indication of the source reference signal includes a transmission configuration indicator state associated with the source reference signal, a reference signal identifier for the source reference signal, one or more downlink control channel monitoring occasion identifiers associated with a set of downlink control channel repetitions, one or more downlink control channel search space identifier associated with a set of downlink control channel repetitions, or any combination thereof.

Aspect 13: The method of any of aspects 1 through 12, further comprising: determining a second differential measurement for the source reference signal based at least in part on measuring a second demodulation reference signal of the plurality of demodulation reference signals; and transmitting, to network entity, a third report indicating the second differential measurement for the source reference signal.

Aspect 14: The method of aspect 13, further comprising: receiving a control message configuring resources for a channel state information report corresponding, the resources corresponding to a periodicity of a semi-periodic scheduling downlink shared channel resource carrying the plurality of demodulation reference signals, wherein the second report is a first channel state information report, and the third report is a second channel state information report.

Aspect 15: The method of any of aspects 1 through 14, wherein transmitting the second report comprises: transmitting a channel state information report indicating the differential measurement.

Aspect 16: The method of any of aspects 1 through 15, further comprising: receiving, from network entity, a control message disabling reporting differential measurements for the source reference signal.

Aspect 17: The method of aspect 16, wherein the control message is received via a medium access control element or downlink control information, or both.

Aspect 18: The method of any of aspects 1 through 17, wherein the plurality of source reference signals are transmitted by a plurality of transmission reception points, the first network entity corresponding to a first transmission reception point of the plurality of transmission reception points.

Aspect 19: The method of any of aspects 1 through 18, wherein the differential measurement is a differential reference signal received power measurement, a differential channel quality indicator measurement, or both, with reference to the measurement for the first beam.

Aspect 20: A method for wireless communications at a network entity, comprising: receiving a first report indicating a measurement for a first beam based at least in part on a source reference signal; transmitting control signaling configuring a UE to report a differential measurement for the source reference signal, wherein the control signaling includes an indication of the source reference signal from a plurality of source reference signals that are quasi co-located with a plurality of demodulation reference signals; and receiving a second report indicating the differential measurement for the source reference signal based at least in part on a demodulation reference signal that is quasi co-located with the source reference signal, wherein the differential measurement is with reference to a most recently reported beam measurement for the source reference signal.

Aspect 21: The method of aspect 20, further comprising: transmitting the demodulation reference signal on a downlink shared channel that is quasi co-located with the source reference signal.

Aspect 22: The method of any of aspects 20 through 21, further comprising: transmitting the demodulation reference signal on a downlink control channel with a frequency domain precoder cycling, wherein the downlink control channel is quasi co-located with the source reference signal.

Aspect 23: The method of aspect 22, wherein transmitting the demodulation reference signal comprises: transmitting the demodulation reference signal in one or more resource element groups associated with the source reference signal based at least in part on the indication of the source reference signal.

Aspect 24: The method of any of aspects 20 through 23, further comprising: transmitting the demodulation reference signal on a downlink control channel with a time domain precoder cycling, wherein the downlink control channel is quasi co-located with the source reference signal.

Aspect 25: The method of any of aspects 20 through 24, further comprising: receiving a third report indicating a second differential measurement for the source reference signal based at least in part on a second demodulation reference signal quasi co-located with a second source reference signal of the plurality of source reference signals.

Aspect 26: The method of any of aspects 20 through 25, further comprising: transmitting a control message disabling reporting differential measurements for the source reference signal.

Aspect 27: The method of any of aspects 20 through 26, wherein the network entity corresponds to a first transmission reception point of a plurality of transmission reception points.

Aspect 28: The method of any of aspects 20 through 27, wherein the differential measurement is a differential reference signal received power measurement, a differential channel quality indicator measurement, or both, with reference to the measurement for the first beam.

Aspect 29: An apparatus for wireless communications at a UE, comprising a processor; memory coupled with the processor; and instructions stored in the memory and executable by the processor to cause the apparatus to perform a method of any of aspects 1 through 19.

Aspect 30: An apparatus for wireless communications at a UE, comprising at least one means for performing a method of any of aspects 1 through 19.

Aspect 31: A non-transitory computer-readable medium storing code for wireless communications at a UE, the code comprising instructions executable by a processor to perform a method of any of aspects 1 through 19.

Aspect 32: An apparatus for wireless communications at a network entity, comprising a processor; memory coupled with the processor; and instructions stored in the memory and executable by the processor to cause the apparatus to perform a method of any of aspects 20 through 28.

Aspect 33: An apparatus for wireless communications at a network entity, comprising at least one means for performing a method of any of aspects 20 through 28.

Aspect 34: A non-transitory computer-readable medium storing code for wireless communications at a network entity, the code comprising instructions executable by a processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
transmit, to a first network entity, a first report indicating a measurement for a first beam based at least in part on a source reference signal;
receive control signaling configuring the UE to report a differential measurement for the source reference signal, wherein the control signaling includes an indication of the source reference signal from a plurality of source reference signals that are quasi co-located with a plurality of demodulation reference signals;
determine the differential measurement for the source reference signal based at least in part on measuring a demodulation reference signal that is quasi co-located with the source reference signal, wherein the differential measurement is determined with reference to a most recently reported beam measurement for the source reference signal; and
transmit, to the first network entity, a second report indicating the differential measurement for the source reference signal.

2. The apparatus of claim 1, wherein the instructions are further executable by the processor to cause the apparatus to:
receive the demodulation reference signal on a downlink shared channel that is quasi co-located with the source reference signal.

3. The apparatus of claim 2, wherein the instructions to determine the differential measurement are executable by the processor to cause the apparatus to:
determine the differential measurement from the demodulation reference signal based at least in part on the demodulation reference signal being associated with a transmission configuration indicator state of the source reference signal.

4. The apparatus of claim 2, wherein the indication of the source reference signal includes a transmission configuration indicator state associated with the source reference signal, a reference signal identifier for the source reference signal, or both.

5. The apparatus of claim 4, wherein the reference signal identifier is a synchronization signal block resource identifier or a channel state information reference signal resource identifier.

6. The apparatus of claim 2, wherein the downlink shared channel is a semi-persistent scheduling downlink shared channel.

7. The apparatus of claim 1, wherein the instructions are further executable by the processor to cause the apparatus to:
receive the demodulation reference signal on a downlink control channel with a frequency domain precoder cycling, wherein the downlink control channel is quasi co-located with the source reference signal.

8. The apparatus of claim 7, wherein the instructions to receive the demodulation reference signal are executable by the processor to cause the apparatus to:
receive the demodulation reference signal in one or more resource element groups associated with the source reference signal based at least in part on the indication of the source reference signal.

9. The apparatus of claim 7, wherein the indication of the source reference signal includes a transmission configuration indicator state associated with the source reference signal, a reference signal identifier for the source reference signal, a group of resource element groups, or any combination thereof.

10. The apparatus of claim 1, wherein the instructions are further executable by the processor to cause the apparatus to:
receive the demodulation reference signal on a downlink control channel with a time domain precoder cycling, wherein the downlink control channel is quasi co-located with the source reference signal.

11. The apparatus of claim 10, wherein the instructions to receive the demodulation reference signal are executable by the processor to cause the apparatus to:
receive the demodulation reference signal in a monitoring occasion associated with the source reference signal, a search space associated with the source reference signal, a control resource set associated with the source reference signal, or any combination thereof, based at least in part on the indication of the source reference signal.

12. The apparatus of claim 10, wherein the indication of the source reference signal includes a transmission configuration indicator state associated with the source reference signal, a reference signal identifier for the source reference signal, one or more downlink control channel monitoring occasion identifiers associated with a set of downlink control channel repetitions, one or more downlink control channel search space identifier associated with a set of downlink control channel repetitions, or any combination thereof.

13. The apparatus of claim 1, wherein the instructions are further executable by the processor to cause the apparatus to:
determine a second differential measurement for the source reference signal based at least in part on measuring a second demodulation reference signal of the plurality of demodulation reference signals; and
transmit, to network entity, a third report indicating the second differential measurement for the source reference signal.

14. The apparatus of claim 13, wherein the instructions are further executable by the processor to cause the apparatus to:
receive a control message configuring resources for a channel state information report corresponding, the resources corresponding to a periodicity of a semi-periodic scheduling downlink shared channel resource carrying the plurality of demodulation reference signals, wherein the second report is a first channel state information report, and the third report is a second channel state information report.

15. The apparatus of claim 1, wherein the instructions to transmit the second report are executable by the processor to cause the apparatus to:
transmit a channel state information report indicating the differential measurement.

16. The apparatus of claim 1, wherein the instructions are further executable by the processor to cause the apparatus to:
receive, from network entity, a control message disabling reporting differential measurements for the source reference signal.

17. The apparatus of claim 16, wherein the control message is received via a medium access control element or downlink control information, or both.

18. The apparatus of claim 1, wherein the plurality of source reference signals are transmitted by a plurality of transmission reception points, the first network entity corresponding to a first transmission reception point of the plurality of transmission reception points.

19. The apparatus of claim 1, wherein the differential measurement is a differential reference signal received power measurement, a differential channel quality indicator measurement, or both, with reference to the measurement for the first beam.

20. An apparatus for wireless communications at a network entity, comprising:
a processor;
memory coupled with the processor; and
instructions stored in the memory and executable by the processor to cause the apparatus to:
receive a first report indicating a measurement for a first beam based at least in part on a source reference signal;
transmit control signaling configuring a user equipment (UE) to report a differential measurement for the source reference signal, wherein the control signaling includes an indication of the source reference signal from a plurality of source reference signals that are quasi co-located with a plurality of demodulation reference signals; and
receive a second report indicating the differential measurement for the source reference signal based at least in part on a demodulation reference signal that is quasi co-located with the source reference signal, wherein the differential measurement is with reference to a most recently reported beam measurement for the source reference signal.

21. The apparatus of claim 20, wherein the instructions are further executable by the processor to cause the apparatus to:
transmit the demodulation reference signal on a downlink shared channel that is quasi co-located with the source reference signal.

22. The apparatus of claim 20, wherein the instructions are further executable by the processor to cause the apparatus to:
transmit the demodulation reference signal on a downlink control channel with a frequency domain precoder cycling, wherein the downlink control channel is quasi co-located with the source reference signal.

23. The apparatus of claim 22, wherein the instructions to transmit the demodulation reference signal are executable by the processor to cause the apparatus to:
transmit the demodulation reference signal in one or more resource element groups associated with the source reference signal based at least in part on the indication of the source reference signal.

24. The apparatus of claim 20, wherein the instructions are further executable by the processor to cause the apparatus to:
transmit the demodulation reference signal on a downlink control channel with a time domain precoder cycling, wherein the downlink control channel is quasi co-located with the source reference signal.

25. The apparatus of claim 20, wherein the instructions are further executable by the processor to cause the apparatus to:
receive a third report indicating a second differential measurement for the source reference signal based at least in part on a second demodulation reference signal quasi co-located with a second source reference signal of the plurality of source reference signals.

26. The apparatus of claim 20, wherein the instructions are further executable by the processor to cause the apparatus to:
transmit a control message disabling reporting differential measurements for the source reference signal.

27. The apparatus of claim 20, wherein the network entity corresponds to a first transmission reception point of a plurality of transmission reception points.

28. The apparatus of claim 20, wherein the differential measurement is a differential reference signal received power measurement, a differential channel quality indicator measurement, or both, with reference to the measurement for the first beam.

29. A method for wireless communications at a user equipment (UE), comprising:
transmitting, to a first network entity, a first report indicating a measurement for a first beam based at least in part on a source reference signal;
receiving control signaling configuring the UE to report a differential measurement for the source reference signal, wherein the control signaling includes an indication of the source reference signal from a plurality of source reference signals that are quasi co-located with a plurality of demodulation reference signals;
determining the differential measurement for the source reference signal based at least in part on measuring a demodulation reference signal that is quasi co-located with the source reference signal, wherein the differential measurement is determined with reference to a most recently reported beam measurement for the source reference signal; and
transmitting, to the first network entity, a second report indicating the differential measurement for the source reference signal.

30. A method for wireless communications at a network entity, comprising:
receiving a first report indicating a measurement for a first beam based at least in part on a source reference signal;
transmitting control signaling configuring a user equipment (UE) to report a differential measurement for the source reference signal, wherein the control signaling includes an indication of the source reference signal from a plurality of source reference signals that are quasi co-located with a plurality of demodulation reference signals; and
receiving a second report indicating the differential measurement for the source reference signal based at least in part on a demodulation reference signal that is quasi co-located with the source reference signal, wherein the differential measurement is with reference to a most recently reported beam measurement for the source reference signal.
